(19) United States
(12) Patent Application Publication
(10) Pub. No.: US 2016/0161295 A1
(43) Pub. Date: Jun. 9, 2016

(54) ENCODER AND MOTOR WITH ENCODER

(71) Applicant: KABUSHIKI KAISHA YASKAWA DENKI, Kitakyushu-shi (JP)

(72) Inventors: Koji UEMURA, Kitakyushu-shi (JP); Yuji ARINAGA, Kitakyushu-shi (JP); Shiro YOSHIDOMI, Kitakyushu-shi (JP); lkuma MUROKITA, Kitakyushu-shi (JP); Hiroshi TAKADA, Kitakyushu-shi (JP); Jiro MURAOKA, Kitakyushu-shi (JP)

(73) Assignee: KABUSHIKI KAISHA YASKAWA DENKI, Kitakyushu-shi (JP)

(21) Appl. No.: 14/960,753

(22) Filed: Dec. 7, 2015

(30) Foreign Application Priority Data
Dec. 9, 2014 (JP) 2014-249448

(51) Int. Cl. G01D 5/347; G01D 5/30

(52) U.S. Cl. CPC G01D 5/3473; G01D 5/30

(57) ABSTRACT

An encoder includes an object body having an absolute pattern formed along a measurement direction, a light source positioned such that the light source emits light to the absolute pattern of the object body, and light receiving elements aligned along the measurement direction such that the light receiving elements receive the light transmitted through or reflected by the absolute pattern of the object body. The light receiving elements include a first light receiving element having a polygonal shape and having a first region in the polygonal shape and a second region formed on an inner side of the first region such that the second region has an optical sensitivity lower than an optical sensitivity of the first region and that the first region includes corner portions of the polygonal shape.

### CROSS-REFERENCE TO RELATED APPLICATIONS

The present application is based upon and claims the benefit of priority to Japanese Patent Application No. 2014-249448, filed Dec. 9, 2014, the entire contents of which are incorporated herein by reference.

### BACKGROUND OF THE INVENTION

1. Field of the Invention

Embodiments of the disclosure relate to an encoder and a motor with the encoder.

2. Description of Background Art

Japanese Patent No. 4945674 describes an encoder in which light receiving elements of an absolute light receiving element group independently detect light signals from an absolute pattern that is capable of uniquely expressing an absolute position of a rotating disc by a combination of positions of reflection slits within a predetermined angle. The entire contents of this publication are incorporated herein by reference.

### SUMMARY OF THE INVENTION

According to one aspect of the present invention, an encoder includes an object body having an absolute pattern formed along a measurement direction, a light source positioned such that the light source emits light to the absolute pattern of the object body, and light receiving elements aligned along the measurement direction such that the light receiving elements receive the light transmitted through or reflected by the absolute pattern of the object body. The light receiving elements include a first light receiving element having a polygonal shape and having a first region in the polygonal shape and a second region formed on an inner side of the first region such that the second region has an optical sensitivity lower than an optical sensitivity of the first region and that the first region includes corner portions of the polygonal shape.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an explanatory diagram illustrating an example of a servo system that includes an encoder according to an embodiment;

FIG. 2 is an explanatory diagram illustrating an example of a structure of the encoder;

FIG. 3 is an explanatory diagram illustrating an example of a structure of a disc;

FIG. 4 is an explanatory diagram illustrating an example of a pattern of the disc;

FIG. 5 is an explanatory diagram illustrating an example of a structure of an optical module of the encoder;

FIG. 6 is an explanatory diagram illustrating an example of a light-receiving operation of A-A cross sections of FIGS. 4 and 5;

FIG. 7 is an explanatory diagram illustrating an example of a light intensity distribution of reflected light on a substrate of the optical module;

FIG. 8 is an explanatory diagram illustrating an example of shapes, formation and dimension settings of low sensitivity regions of a light receiving element provided in the optical module;

FIG. 9 is an explanatory diagram illustrating an example of variation characteristics of an analog detection signal in a case of a rectangular light receiving element that does not have a low sensitivity region;

FIG. 10 is an explanatory diagram illustrating an example of variation characteristics of an analog detection signal in a case of a light receiving element that has a low sensitivity region at a measurement-direction center position;

FIG. 11 is an explanatory diagram illustrating an example of variation characteristics of an analog detection signal in a case of a light receiving element in which low sensitivity regions are formed such that a width-direction dimension of a high sensitivity region is the largest at a measurement-direction center position of the light receiving element;

FIG. 12 is an explanatory diagram illustrating an example of a difference in variation characteristics between received light amounts of a light receiving element that does not have a low sensitivity region and a light receiving element that has a low sensitivity region at a measurement-direction center position;

FIG. 13 is an explanatory diagram illustrating an example of a difference in variation characteristics between received light amounts of a light receiving element that does not have a low sensitivity region and a light receiving element in which low sensitivity regions are formed such that a width-direction dimension of a high sensitivity region is maximized at a measurement-direction center position of the light receiving element;

FIG. 14 is an explanatory diagram illustrating an example of shapes of light receiving elements of a light receiving array according to the embodiment;

FIG. 15 is an explanatory diagram illustrating an example of shapes of light receiving elements according to a modified embodiment in which positions of low sensitivity regions are modified;

FIG. 16 is an explanatory diagram illustrating an example of shapes of light receiving elements according to a modified embodiment in which areas of low sensitivity regions are modified;

FIG. 17 is an explanatory diagram illustrating an example of shapes of light receiving elements according to a modified embodiment in which formation densities of low sensitivity regions are modified;

FIG. 18 is an explanatory diagram illustrating an example of shapes of light receiving elements according to a modified embodiment in which positions and areas of low sensitivity regions are modified;

FIG. 19 is an explanatory diagram illustrating an example of low sensitivity regions having shapes other than inner-cutout shapes;

FIG. 20 is an explanatory diagram illustrating another example of low sensitivity regions having shapes other than inner-cutout shapes;

FIG. 21 is an explanatory diagram illustrating another example of low sensitivity regions having shapes other than inner-cutout shapes;

FIG. 22 is an explanatory diagram illustrating an example of shapes of light receiving elements according to a modified embodiment in which a width-direction dimension of a high sensitivity region is minimized at a measurement-direction center position of a light receiving element; and

FIG. 23 is an explanatory diagram illustrating an example of shapes of light receiving elements according to a modified embodiment in which a width-direction dimension of a high sensitivity region is minimized at a measurement-direction center position of a light receiving element.

### DETAILED DESCRIPTION OF THE EMBODIMENTS

The embodiments will now be described with reference to the accompanying drawings, wherein like reference numerals designate corresponding or identical elements throughout the various drawings.

An encoder according to the embodiment to be described below is applicable to various types of encoders such as a rotary type encoder and a linear type encoder. In the following, to facilitate understanding of the encoder, a rotary type encoder is described as an example. When the encoder according to the embodiment is applied to an encoder of another type, it is possible by adding appropriate modifications such as changing an object to be measured from a disc of a rotary type to a linear scale of a linear type. Therefore, detailed description is omitted.

### Servo System

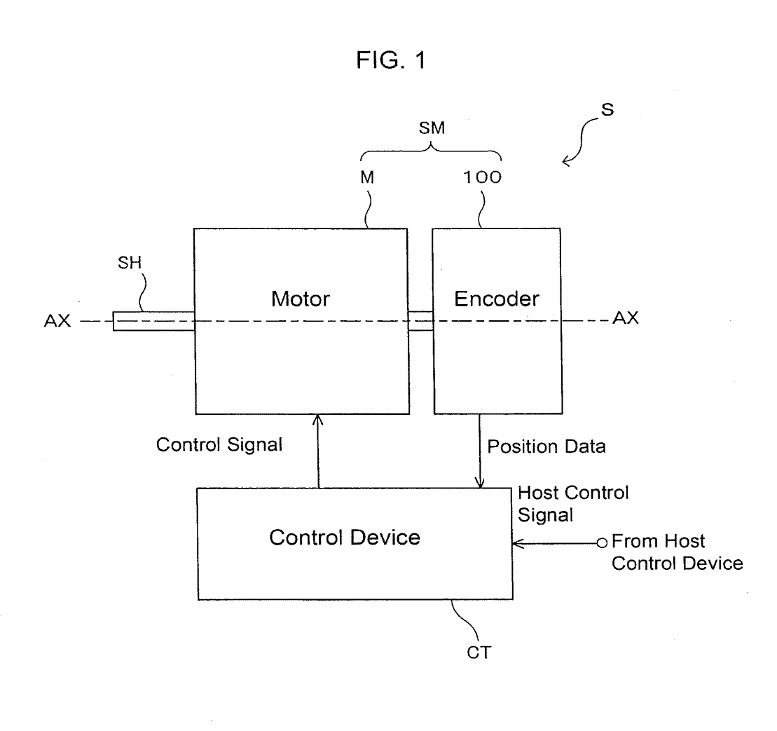

First, with reference to FIG. 1, a structure of a servo system that is provided with the encoder according to the present embodiment is described. As illustrated in FIG. 1, a servo system (S) includes a servo motor (SM) and a control device (CT). The servo motor (SM) includes an encoder 100 and a motor (M).

The motor (M) is an example of a power generation source that does not include the encoder 100. The motor (M) is a rotary type motor in which a rotor (not illustrated in the drawings) rotates relative to a stator (not illustrated in the drawings), and outputs a torque by rotating a shaft (SH) that is fixed to the rotor about an axis (AX).

There are also cases where the motor (M) alone is referred to as a servo motor. However, in the present embodiment, a structure that includes the encoder 100 is referred to as the servo motor (SM). That is, the servo motor (SM) corresponds to an example of a motor with an encoder. In the following, for convenience of description, a case is described where a motor with an encoder is a servo motor that is controlled so as to follow target values of a position, a speed, and the like. However, a motor with an encoder is not limited to such a case of being a servo motor. A motor with an encoder may also be a motor that is used in a system other than a servo system as long as an encoder is attached, for example, as in a case where a motor is used only for displaying an output of an encoder.

Further, the motor (M) is not particularly limited as long as it is a motor that allows the encoder 100 to detect, for example, position data and the like. Further, the motor (M) is not limited to a case of being an electric motor that uses electricity as a power source. For example, the motor (M) may also be a motor that uses another type of power source, such as a hydraulic motor, a pneumatic motor, a steam motor, or the like. However, for convenience of description, in the following, a case where the motor (M) is an electric motor is described.

The encoder 100 is connected to an opposite side of a torque output side of the shaft (SH) of the motor (M). However, without being necessarily limited to the opposite side, the encoder 100 may also be connected to the torque output side of the shaft (SH). The encoder 100 detects a position (also referred to as a “rotation angle”) of the motor (M) by detecting a position of the shaft (SH) (rotor) and outputs position data that indicates the position. The encoder 100 is not limited to the case of being directly connected to the motor (M), but may also be connected to the motor (M) via other mechanisms such as a brake device, a speed reducer, a rotation direction converter, and the like.

The encoder 100 may also detect at least one of a speed (also referred to as a “rotational speed,” an “angular speed,” or the like) of the motor (M) and an acceleration (also referred to as a “rotational acceleration,” an “angular acceleration,” or the like) of the motor (M) in addition to or in place of the position of the motor (M). In this case, the speed and the acceleration of the motor (M) can be detected by a process such as differentiating once or twice the position with respect to time or counting detection signals (such as incremental signals to be described later) for a predetermined time period. For convenience of description, in the following, a case is described where a physical quantity that the encoder 100 detects is the position.

The control device (CT) acquires position data output from the encoder 100 and controls rotation of the motor (M) based on the position data. Therefore, in the present embodiment in which an electric motor is used as the motor (M), the control device (CT) controls, based on the position data, the rotation of the motor (M) by controlling a current, a voltage, or the like, that is applied to the motor (M). Further, it is also possible that the control device (CT) acquires a host control signal from a host control device (not illustrated in the drawings) and controls the motor (M) so that a torque that allows a position or the like that is indicated by the host control signal to be realized is output from the shaft (SH) of the motor (M). When the motor (M) uses another type of power source such as a hydraulic, a pneumatic or a steam power source, the control device (CT) can control the rotation of the motor (M) by controlling a supply of the power source.

### Encoder

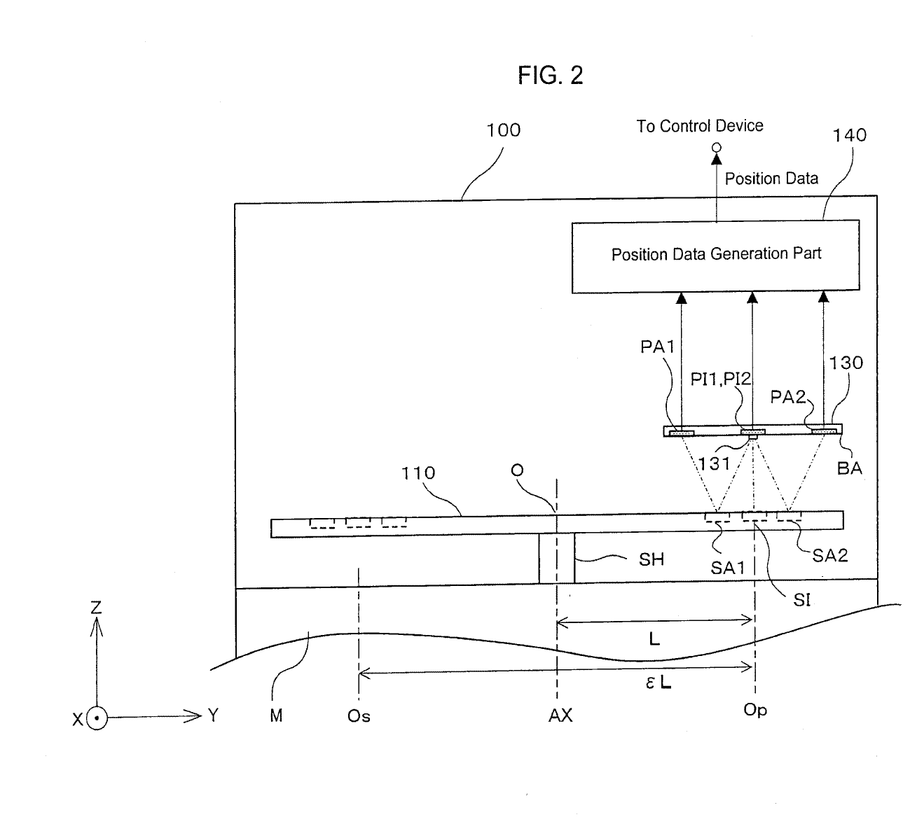

Next, the encoder 100 according to an embodiment of the present invention is described. As illustrated in FIG. 2, the encoder 100 includes a disc 110, an optical module 130 and a position data generation part 140. The encoder 100 is a so-called reflection type encoder in which a light source 131 and light receiving arrays (PA1, PA2) or the like that are provided in an optical module 130 are positioned on the same side relative to patterns (SA1, SA2) and the like of the disc 110. However, without being limited to a reflection type encoder, the encoder 100 may also be a so-called transmission type encoder in which the light source 131 and the light receiving arrays (PA1, PA2) or the like are positioned on opposite sides sandwiching the disc 110 therebetween. However, for convenience of description, in the following, a case is described where the encoder 100 is a reflection type encoder.

Here, for convenience of description of a structure of the encoder 100, directions such as up, down, and the like, are defined as follows and used as appropriate. In FIG. 2, a direction along which the disc 110 faces the optical module 130, that is, a positive direction of a Z-axis, is an “up” direction and a negative direction of the Z-axis is a “down” direction. However, the directions vary depending on an installation mode of the encoder 100 and the like, and are not intended to limit a positional relation between the respective structural elements of the encoder 100.

### Disc

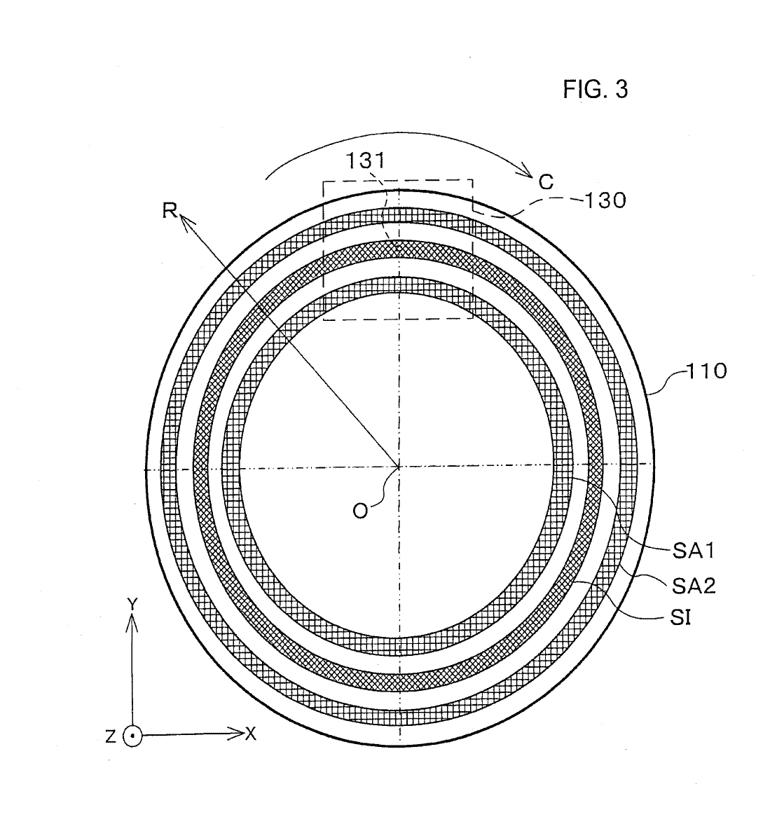

As illustrated in FIG. 3, the disc 110 is formed in a shape of a circular plate and is positioned such that a disc center (O) substantially coincides with the axis (AX). The disc 110 is connected to the shaft (SH) of the motor (M), and is rotated by the rotation of the shaft (SH). In the present embodiment, the disc 110 in a shape of a circular plate is described as an example of an object to be measured that measures the rotation of the motor (M). However, it is also possible that another member such as an end surface of the shaft (SH) is used as an object to be measured. Further, in an example illustrated in FIG. 2, the disc 110 is directly connected to the shaft (SH). However, it is also possible that the disc 110 is connected to the shaft (SH) via a connecting member such as a hub.

As illustrated in FIG. 3, the disc 110 has multiple patterns (SA1, SA2, SI). The disc 110 rotates together with driving of the motor (M). However, the optical module 130 is fixedly positioned while opposing a portion of the disc 110. Therefore, along with the driving of the motor (M), the patterns (SA1, SA2, SI) and the optical module 130 move relative to each other in a measurement direction (direction of an arrow (C) illustrated in FIG. 3; hereinafter referred to as the “measurement direction (C)” as appropriate).

Here, the “measurement direction” is a measurement direction when the patterns formed in the disc 110 are optically measured by the optical module 130. In a rotary type encoder in which an object to be measured is the disc 110 as in the present embodiment, the measurement direction coincides with a circumferential direction of the disc 110. However, for example, in a linear type encoder in which an object to be measured is a linear scale and a mover moves relative to a stator, the measurement direction is a direction along the linear scale.

### Optical Detection Mechanism

An optical detection mechanism is structured by the patterns (SA1, SA2, SI), the optical module 130 and the like.

### Patterns

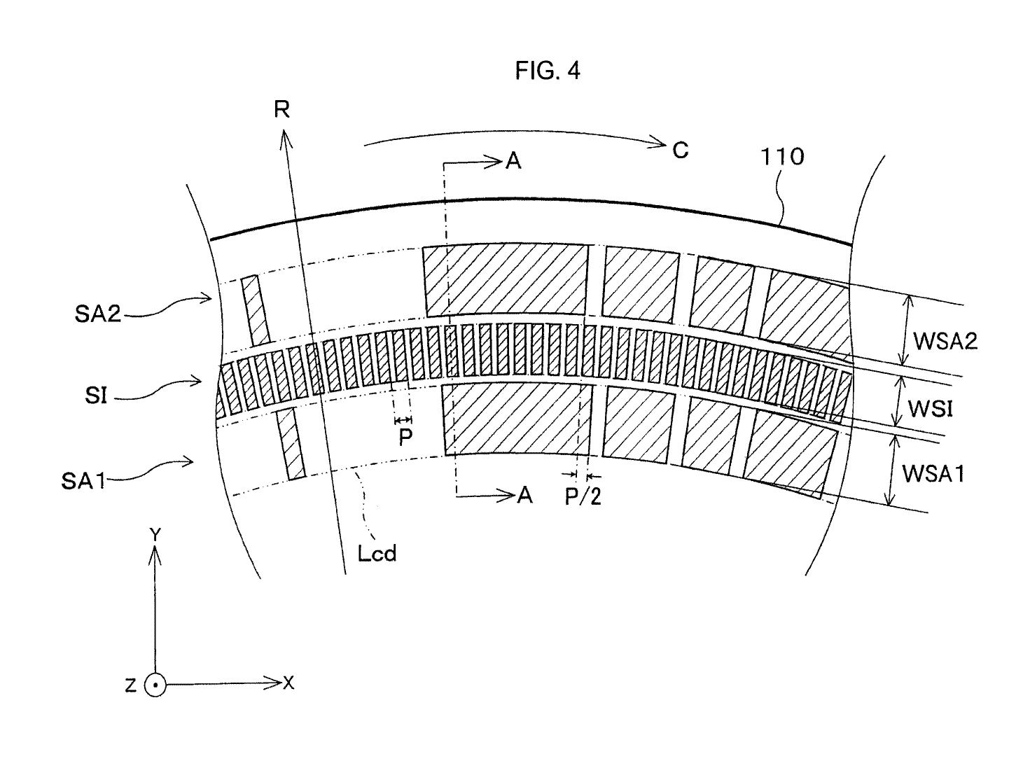

The patterns are each formed as a track that is arrayed in a ring shape around the disc center (0) on an upper surface of the disc 110. The patterns each have multiple reflection slits (oblique line hatched portions in FIG. 4) arrayed over the entire circumference of the track along the measurement direction (C). Each of the reflection slits reflects light emitted from the light source 131.

The disc 110 is formed using a material such as metal that reflects light. By forming, such as by coating, a material having low reflectance (such as chromium oxide) on portions that are not to reflect light on the upper surface of the disc 110, the reflection slits are formed at portions where the material is not formed. It is also possible that the reflection slits are formed by reducing the reflectance of the portions that are not to reflect light as rough surface portions by subjecting these portions to sputtering or the like.

The material, the manufacturing method and the like of the disc 110 are not particularly limited. For example, it is possible that the disc 110 is formed using a material such as glass or transparent resin that transmits light. In this case, the reflection slits can be formed by forming a material (such as aluminum) that reflects light on the upper surface of the disc 110 by vapor deposition or the like.

In a case where the encoder 100 is structured as the above-described transmission type encoder, the patterns that are formed on the disc 110 each have multiple transmission slits arrayed over the entire circumference of the track along the measurement direction (C). Each of the transmission slits transmits light emitted from the light source 131.

Three patterns are provided side by side on the upper surface of the disc 110 in a width direction (direction of an arrow (R) illustrated in FIG. 3; hereinafter referred to as the “width direction (R)” as appropriate). The “width direction” is a radial direction of the disc 110, that is, a direction that is substantially perpendicular to the measurement direction (C). A length of each pattern along the width direction (R) corresponds to a width of the pattern. The three patterns are concentrically formed in the order of the pattern (SA1), the pattern (SI) and the pattern (SA2) from an inner side to an outer side of the width direction (R). In order to describe each of the patterns in more detail, an enlarged view of a portion near a region of the disc 110 that opposes the optical module 130 is illustrated in FIG. 4.

### Absolute Patterns

As illustrated in FIG. 4, the reflection slits that the patterns (SA1, SA2) each have are formed over the entire circumference of the disc 110 so as to have an absolute pattern along the measurement direction (C). These patterns (SA1, SA2) correspond to examples of absolute patterns.

Here, the “absolute pattern” means a pattern in which a position, a proportion, and the like of a reflection slit within an angle to which a light receiving array that the optical module 130 (to be described later) has opposes are uniquely defined within one revolution of the disc 110. That is, for example, in a case of an example of an absolute pattern illustrated in FIG. 4, when the motor (M) is at a certain angular position, a bit pattern combination due to detection or no detection in multiple light receiving elements of the opposing light receiving array uniquely represents an absolute position of the angular position. The “absolute position” means an angular position relative to a point of origin within one revolution of the disc 110. The point of origin is set to an appropriate angular position within one revolution of the disc 110, and the absolute pattern is formed with the point of origin as a reference.

According to an example of the pattern, a pattern can be generated in which the absolute position of the motor (M) is one-dimensionally represented by bits in the number of the light receiving elements of the light receiving array. However, the absolute pattern is not limited to this example. For example, the absolute pattern may also be a pattern that is multi-dimensionally represented by bits of the number of the light receiving elements. Further, in addition to a predetermined bit pattern, various other patterns are also possible such as a pattern that varies in such a manner that a physical quantity such as an intensity or a phase of light received by the light receiving elements uniquely represents the absolute position, and a pattern obtained by subjecting a code sequence of an absolute pattern to modulation.

In the present embodiment, identical absolute patterns are formed in the measurement direction (C) offset from each other, for example, by ½ the length of one bit and are formed as the two patterns (SA1, SA2). The offset amount corresponds to one half of a pitch (P) of reflection slits of the pattern (SI). Suppose such a structure in which the patterns (SA1, SA2) are formed offset from each other is not adopted, the following is possible. That is, when an absolute position is represented by an one-dimensional absolute pattern as in the present embodiment, in a transition region of a bit pattern due to that the light receiving elements of the light receiving arrays (PA1, PA2) are positioned opposing a vicinity of an end portion of a reflection slit, there is a possibility that detection accuracy of the absolute position decreases. In the present embodiment, the patterns (SA1, SA2) are offset from each other. Therefore, for example, when an absolute position according to the pattern (SA1) corresponds to a transition region of a bit pattern, a detection signal from the pattern (SA2) is used to calculate an absolute position, and vice versa. Thereby, the detection accuracy of the absolute position can be improved. When such a structure is adopted, amounts of light received by the two light receiving arrays (PA1, PA2) are equalized. However, in the present embodiment, the two light receiving arrays (PA1, PA2) are positioned at substantially equal distances from the light source 131. Therefore, the above structure can be realized.

Instead of offsetting the absolute patterns of the patterns (SA1, SA2) from each other, it is also possible that, for example, without offsetting the absolute patterns from each other, the light receiving arrays (PA1, PA2) that respectively correspond to the patterns (SA1, SA2) are offset from each other.

Further, it is not always necessary that two absolute patterns are formed. It is also possible that only one absolute pattern is formed. However, in the following, for convenience of description, the case where the two patterns (SA1, SA2) are formed is described.

### Incremental Pattern

On the other hand, the reflection slits that the pattern (SI) has are arrayed over the entire circumference of the disc 110 so as to have an incremental pattern along the measurement direction (C).

As illustrated in FIG. 4, the “incremental pattern” is a pattern that is regularly repeated at a predetermined pitch. Here, the “pitch” means an array interval of the reflection slits of the pattern (SI) that has an incremental pattern. As illustrated in FIG. 4, the pitch of the pattern (SI) is P. Unlike the absolute pattern in which presence of absence of a detection signal by the light receiving elements is used as a bit to represent the absolute position, the incremental pattern uses a sum of detection signals of at least one light receiving element to represent a position of the motor (M) of each one pitch or within one pitch. Therefore, the incremental pattern does not represent an absolute position of the motor (M), but can represent a position with very high accuracy as compared to the absolute pattern.

In the present embodiment, a minimum length of the reflection slits of the patterns (SA1, SA2) in the measurement direction (C) coincides with the pitch (P). As a result, resolution of an absolute signal based on the patterns (SA1, SA2) coincides with the number of the reflection slits of the pattern (SI). However, the minimum length is not limited to this example. It is desirable that the number of the reflection slits of the pattern (SI) be formed to be the same as or more than the resolution of the absolute signal.

### Optical Module

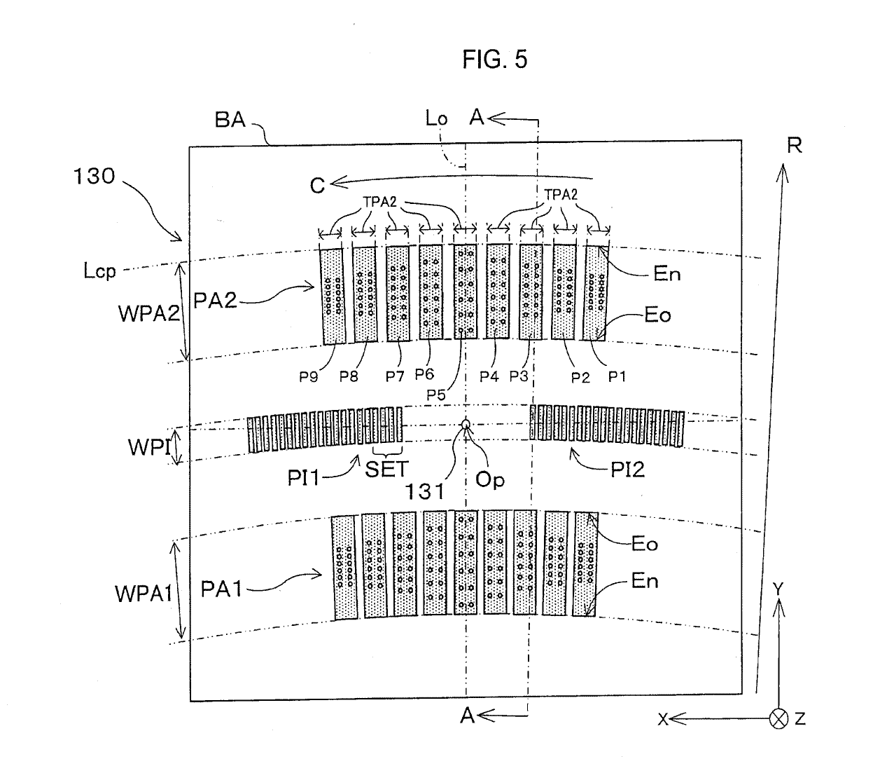

As illustrated in FIGS. 2 and 5, the optical module 130 is formed as one sheet of a substrate (BA) parallel to the disc 110. As a result, the encoder 100 can be made thin, and the optical module 130 can be easily manufactured. Therefore, along with the rotation of the disc 110, the optical module 130 relatively moves in the measurement direction (C) with respect to the patterns (SA1, SA2, SI). The optical module 130 is not necessarily required to be formed as one sheet of the substrate (BA). It is also possible that the respective structures are formed as substrates. In this case, these substrates may be integrally formed. Further, it is also possible that the optical module 130 is not formed in a shape of a substrate.

As illustrated in FIGS. 2 and 5, the optical module 130 has, on surface of the substrate (BA) opposing the disc 110, the light source 131 and the multiple light receiving arrays (PA1, PA2, PI1, PI2).

### Light Source

As illustrated in FIG. 3, the light source 131 is positioned at a position opposing the pattern (SI). The light source 131 emits light to a portion opposing the three patterns (SA1, SA2, SI) that pass through an opposing position of the optical module 130.

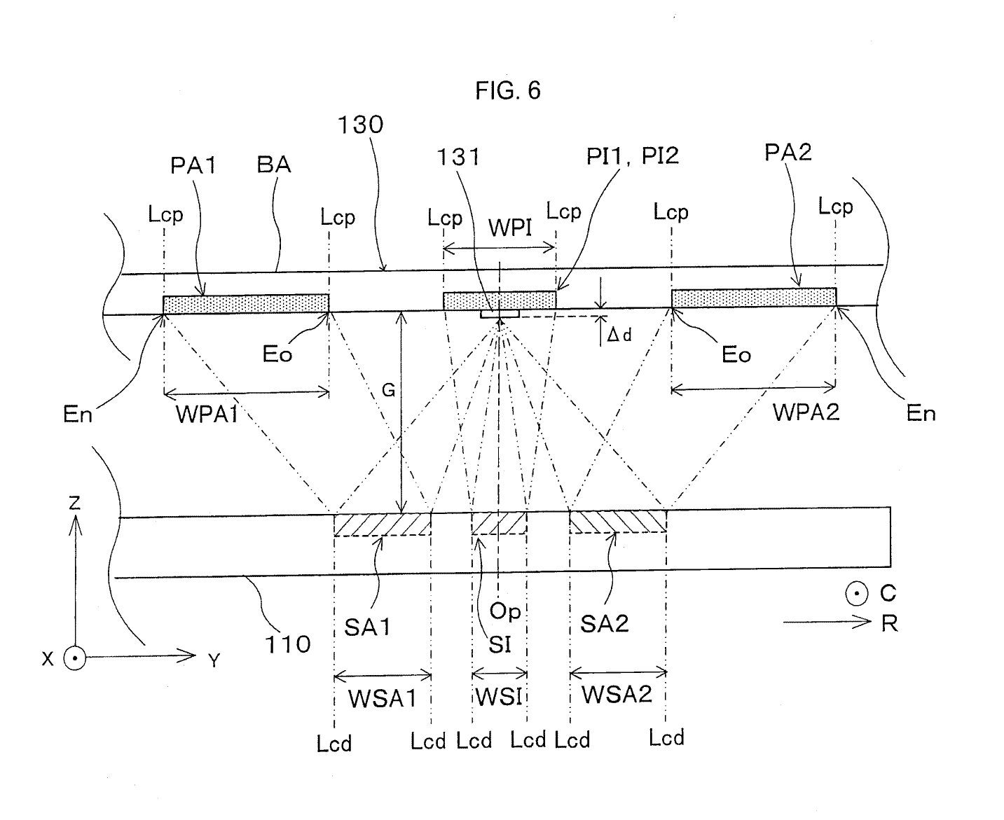

The light source 131 is not particularly limited as long as it is a light source capable of emitting light to an irradiation area. For example, as the light source 131, an LED (Light Emitting Diode) can be used. As illustrated in FIG. 6, the light source 131 is structured as a point light source in which an optical lens or the like is not particularly positioned, and diffused light is emitted from a light emitting part. The “point light source” is not necessary to be strictly a point. It is also possible that light is emitted from a finite surface as long as the light source can be regarded as a light source that emits diffused light from a substantially point-like position from a viewpoint of design or an operating principle. Further, the “diffused light” is not limited to light that is omnidirectionally emitted from a point light source, but also includes light that is emitted toward a certain finite range of directions while being diffused. That is, as long as light is more diffusive than parallel light, the light is included in the diffused light as referred to here. In this way, by using a point light source, the light source 131 can substantially evenly emit light to the three patterns (SA1, SA2, SI) that pass through the position opposing the light source 131. Further, light condensing and diffusion using an optical element is not performed. Therefore, an error or the like due to the optical element is unlikely to occur, and rectilinearity of light emitted toward the patterns can be improved.

### Enlargement Ratio of Projection Image

The light receiving arrays are positioned around the light source 131 and have multiple light receiving elements (dot hatched portions in FIG. 5) that respectively receive light reflected by the reflection slits of the corresponding patterns. As illustrated in FIG. 5, the light receiving elements are arrayed along the measurement direction (C).

As illustrated in FIG. 6, light emitted from the light source 131 is diffused light. Therefore, images of the patterns projected onto the optical module 130 are enlarged by a predetermined enlargement ratio (ε) corresponding to an optical path length. That is, as illustrated in FIG. 4-6, when lengths of the patterns (SA1, SA2, SI) in the width direction (R) are respectively WSA1, WSA2 and WSI, and lengths of shapes of the patterns (SA1, SA2, SI) projected onto the optical module 130 in the width direction (R) are respectively WPA1, WPA2 and WPI, WPA1, WPA2 and WPI are respectively ε times of WSA1, WSA2 and WSI. In the present embodiment, as illustrated in FIGS. 5 and 6, an example is illustrated in which the lengths of the light receiving elements of the light receiving arrays in the width direction (R) are set to be substantially equal to those of the shapes projected onto the optical module 130 by the reflection slits. However, the lengths of the light receiving elements in the width direction (R) are not necessarily limited this example.

Similarly, the measurement direction (C) on the optical module 130 is also a shape projected onto the optical module 130 by the measurement direction (C) on the disc 110, that is, a shape affected by the enlargement ratio (ε). To make understanding easy, as illustrated in FIG. 2, the measurement direction (C) at the position of the light source 131 is described in detail as an example. The measurement direction (C) of the disc 110 is in a circular shape centered on the axis (AX). In contrast, a center of the measurement direction (C) projected onto the optical module 130 is at a position that is separated by a distance (εL) from an optical center (Op), which is a position on the surface of the disc 110 where the light source 131 is positioned. The distance (εL) is a distance obtained by enlarging a distance (L) between the axis (AX) and the optical center (Op) by the enlargement ratio (ε). This position is conceptually illustrated as a measurement center (Os) in FIG. 2. Therefore, the measurement direction (C) on the optical module 130 is on a line having the distance (εL) as a radius and the measurement center (Os) as a center, the measurement center (Os) being separated by the distance (εL) from the optical center (Op) in a direction toward the rotation axis (AX) on a line passing through the optical center (Op) and the axis (AX).

In FIG. 4-6, a correspondence relation between the respective measurement directions (C) of the disc 110 and the optical module 130 is expressed using arc-shaped lines (Lcd, Lcp). The line (Lcd) illustrated in FIG. 4 and the like represents a line along the measurement direction (C) on the disc 110, and the line (Lcp) illustrated in FIG. 5 and the like represents a line along the measurement direction (C) on the substrate (BA) (a line projected onto the optical module 130 by the line (Lcd)).

As illustrated in FIG. 6, when a gap length between the optical module 130 and the disc 110 is G and a protrusion amount of the light source 131 from the substrate (BA) is Δd, the enlargement ratio (ε) is represented by the following Formula 1.

ε=(2G−Δd)/(G−Δd) Formula 1

### Absolute and Incremental Light Receiving Arrays

As a light receiving element, for example, a photodiode can be used. Each of the light receiving elements is formed to have a predetermined light receiving area and outputs an analog detection signal of a magnitude corresponding to a total light amount (hereinafter, referred to as a “received light amount”) that is received by the entire light receiving area. However, a light receiving element is not limited to a photodiode, and is not particularly limited as long as the light receiving element is an element that is capable of receiving light emitted from the light source 131 and converting the received light to an electrical signal.

The light receiving arrays in the present embodiment are positioned in correspondence to the three patterns (SA1, SA2, SI). The light receiving array (PA1) is formed to receive light reflected by the pattern (SA1); and the light receiving array (PA2) is formed to receive light reflected by the pattern (SA2). Further, the light receiving arrays (PI1, PI2) are formed to receive light reflected by the pattern (SI). The light receiving array (PI1) and the light receiving array (PI2) correspond to the same track, although being divided along the way. As just described, the number of light receiving arrays corresponding to one pattern is not limited to one, but may also be two or more.

The light source 131 and the light receiving arrays (PA1, PA2) are positioned in a positional relation illustrated in FIG. 5. That is, the two light receiving arrays (PA1, PA2) corresponding to the absolute patterns are positioned in parallel at positions offset from each other in the width direction (R) sandwiching the light source 131 therebetween. In this example, the light receiving array (PA1) is positioned on an inner peripheral side, and the light receiving array (PA2) is positioned on an outer peripheral side. A distance between the light receiving array (PA1) and the light source 131 and a distance between the light receiving array (PA2) and the light source 131 are substantially equal to each other. The light receiving arrays (PA1, PA2) are each formed in a line-symmetrical shape about a line (Lo) that passes through the light source 131 (optical center (Op)) and is parallel to a Y-axis. The multiple (in the present embodiment, for example, nine) light receiving elements that each of the light receiving arrays (PA1, PA2) has are arrayed at a constant pitch along the measurement direction (C) (line (Lcp)). Shapes of the light receiving elements will be described later.

In the present embodiment, one-dimensional patterns are illustrated as the absolute patterns. Therefore, the light receiving arrays (PA1, PA2) corresponding to the patterns each have the multiple (in the present embodiment, for example, nine) light receiving elements arrayed along the measurement direction (C) (line (Lcp)) so as to respectively receive light reflected by the reflection slits of the associated patterns (SA1, SA2). The light receiving elements, in which, as described above, light reception or no light reception of each of the light receiving elements is treated as a bit, represents a 9-bit absolute position. Light receiving signals that are respectively received by the light receiving elements are treated independently from each other in the position data generation part 140 (see FIG. 2) and thereby, an absolute position that has been encrypted (encode) into a serial bit pattern is decoded from a combination of the light receiving signals. The “light receiving signals” of the light receiving arrays (PA1, PA2) are referred to as the “absolute signals.” When an absolute pattern different from that of the present embodiment is used, the light receiving arrays (PA1, PA2) adopt structures corresponding to the pattern. The number of the light receiving elements that each of the light receiving arrays (PA1, PA2) has may be other than nine, and the number of bits of the absolute signals is also not limited to nine.

The light source 131 and the light receiving arrays (PI1, PI2) are positioned in a positional relation illustrated in FIG. 5. That is, the light receiving arrays (PI1, PI2) corresponding to the incremental pattern are positioned sandwiching the light source 131 therebetween in the measurement direction (C). Specifically, the light receiving arrays (PI1, PI2) are positioned so as to be line-symmetrical with the above-described line (Lo) as an axis of symmetry. The light source 131 is positioned between the light receiving arrays (PI1, PI2) that are arrayed as one track in the measurement direction (C).

The light receiving arrays (PI1, PI2) have the light receiving elements that arrayed along the measurement direction (C) (line (Lcp)) so as to respectively receive light reflected by the reflection slits of the associated pattern (SI). These light receiving elements each have the same shape (a rectangular shape in this example).

In the present embodiment, in one pitch of the incremental pattern of the pattern (SI) (one pitch in a projected image, that is, ε×P), a set (indicated by “SET” in FIG. 5) of a total of four light receiving elements is positioned, and multiple sets each including four light receiving elements are further arrayed along the measurement direction (C). In the incremental pattern, one reflection slit is repeated formed for each one pitch. Therefore, when the disc 110 rotates, each of the light receiving elements in one pitch generates one period (referred to as 360° in an electrical angle) worth of a periodic light receiving signal. Four light receiving elements are arrayed in one set corresponding to one pitch. Therefore, the light receiving elements adjacent to each other in one set output incremental phase signals that are periodic signals having 90-degree phase differences between each other. These incremental phase signals are respectively referred to as an “A+ phase signal,” a “B+ phase signal” (having a 90-degree phase difference with respect to the A+ phase signal), an “A− phase signal” (having a 180-degree phase difference with respect to the A+ phase signal) and a “B− phase signal” (having a 180-degree phase difference with respect to the B+ phase signal).

The incremental pattern represents a position within one pitch. Therefore, the phase signals in one set and corresponding phase signals in another set have similarly varying values. Therefore, phase signals of the same phase are summed over multiple sets. Therefore, from the large number of the light receiving elements of each of the light receiving arrays (PI1, PI2) illustrated in FIG. 5, four signals of which the phases are shifted by 90 degrees from each other are detected. Therefore, from each of the light receiving arrays (PI1, PI2), four signals of which the phases are shifted by 90 degrees from each other are generated. These four signals are referred to as the “incremental signals.”

In the present embodiment, a case is described as an example where four light receiving elements are included on one set corresponding to one pitch of the incremental pattern, and the light receiving array (PI1) and the light receiving array (PI2) each have sets of the same structure. However, the number of the light receiving elements that are included in one set is not particularly limited. For example, it is also possible that two light receiving elements are included in one set. Further, the number of the light receiving elements of the entire light receiving arrays (PI1, PI2) is also not limited to the example illustrated in FIG. 5 and the like. Further, the light receiving arrays (PI1, PI2) may also be respectively formed to acquire light receiving signals of different phases.

Further, the present invention is not limited to a mode in which two light receiving arrays corresponding to an incremental pattern are positioned sandwiching the light source 131 therebetween as in the case of the light receiving arrays (PI1, PI2). For example, it is also possible that one light receiving array is positioned along the measurement direction (C) on an outer peripheral side or an inner peripheral side of the light source 131. Further, it is also possible that incremental patterns of different resolutions are formed on multiple tracks of the disc 110, and multiple light receiving arrays corresponding to the tracks are provided.

In the above, an overview of the light receiving arrays is described. Next, before describing shapes and the like of the light receiving elements of the light receiving arrays (PA1, PA2), the position data generation part 140, which is a remaining structure, is described.

### Position Data Generation Part

At a timing at which the absolute position of the motor (M) is measured, the position data generation part 140 acquires, from the optical module 130, two absolute signals that each have a bit pattern representing a first absolute position and incremental signals including four signals of which phases are shifted by 90 degrees relative to each other. Then, based on the acquired signals, the position data generation part 140 calculates a second absolute position of the motor (M) represented by the signals, and outputs position data that represents the calculated second absolute position to the control device (CT).

A method for generating the position data using the position data generation part 140 is not particularly limited, and various methods can be used. Here, a case is described as an example where, from the incremental signals and the absolute signals, the absolute position is calculated and the position data is generated.

The position data generation part 140 binarizes each of the absolute signals from the light receiving arrays (PA1, PA2) and converts the binary data into bit data representing an absolute position. Then, a first absolute position is identified based on a predetermined correspondence relation between bit data and an absolute position. That is, here, the “first absolute position” is an absolute position of a low resolution before the incremental signals are superimposed. On the other hand, among the incremental signals of four phases from the light receiving arrays (PI1, PI2), incremental signals having a 180-degree phase difference relative to each other are subtracted from each other. In this way, by performing subtraction between the signals having a 180-degree phase difference relative to each other, a manufacturing error, a measurement error or the like of the reflection slits within one pitch can be offset. Signals of the results calculated as described above are here referred to as a “first incremental signal” and a “second incremental signal.” The first incremental signal and the second incremental signal have a 90-degree phase difference relative to each other in the electrical angle (simply referred to as an “A-phase signal” and a “B-phase signal”). Therefore, from these two signals, the position data generation part 140 identifies a position with one pitch. A method for identifying the position within one pitch is not particularly limited. For example, when the incremental signals that are periodic signals are sinusoidal signals, as an example of the above identification method, there is a method in which an electrical angle (φ) is calculated by performing arctan calculation on a division result of the two A-phase and B-phase sinusoidal signals. Alternatively, there is also a method in which a tracking circuit is used to convert the two sinusoidal signals to an electrical angle (φ). Alternatively, there is also a method in which an electrical angle (φ) associated with values of the A-phase and B-phase signals is identified in a table that is prepared in advance. In this case, the position data generation part 140 preferably performs analog-to-digital conversion for each detection signal of the two A-phase and B-phase sinusoidal signals.

The position data generation part 140 superimposes the position within one pitch that is identified based on the incremental signals on the first absolute position that is identified based on the absolute signals. As a result, a second absolute position can be calculated having a resolution higher than the first absolute position based on the absolute signals. The position data generation part 140 subjects the second absolute position that is calculated as described above to a multiplication process to further improve the resolution of the second absolute position and thereafter outputs the second absolute position as position data representing a highly accurate absolute position to the control device (CT).

### Shapes of Light Receiving Elements of Absolute Light Receiving Arrays

Shapes of the light receiving elements of the light receiving arrays (PA1, PA2) are described.

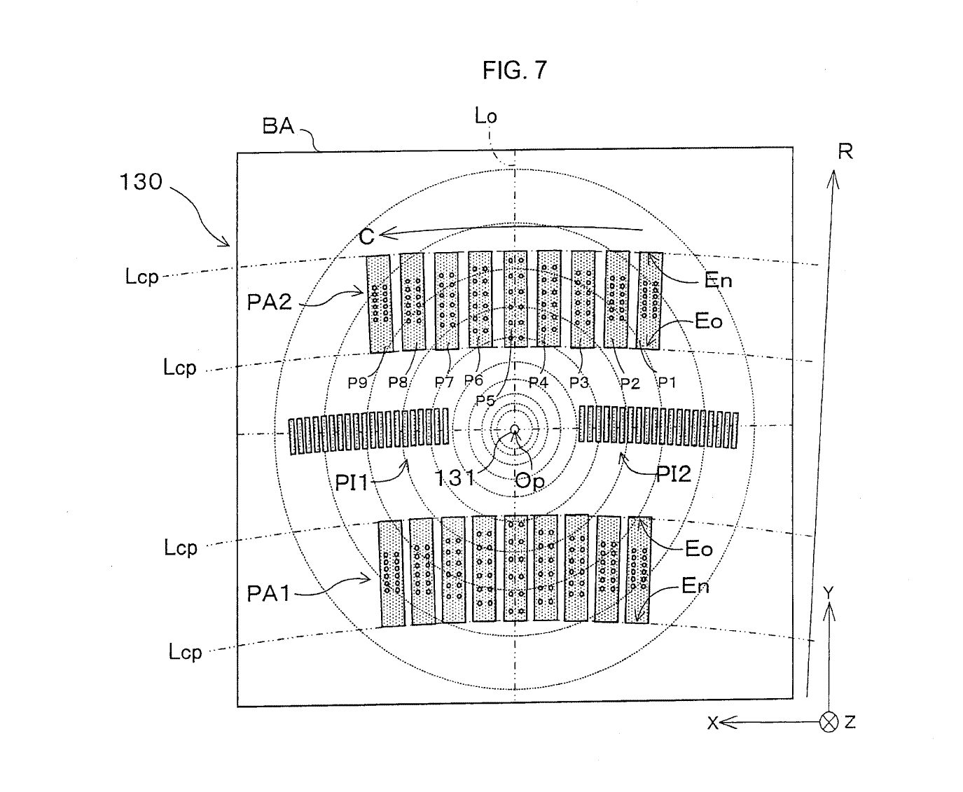

Suppose the diffused light emitted from the light source 131 is all reflected on the disc 110 and is irradiated to the substrate (BA) of the optical module 130, as illustrated in FIG. 7, intensity distribution of the reflected light is concentric distribution that attenuates with increasing distance from the optical center (Op). Dotted circles in FIG. 7 represent isointensity lines of the reflected light. The light intensity is higher on an inner peripheral side and is lower on an outer peripheral side. The reason that the light intensity distribution of the reflected light is concentric distribution as described above is because light has a property of attenuating with optical path length and because a structure is adopted in which the reflected light is received on the planar substrate (BA) that is perpendicular to an optical axis in an irradiation space (reflection space) of the diffused light from the light source 131. Actually, the reflected light is irradiated to regions on the substrate (BA) that respectively correspond to the patterns (SA1, SA2, SI) of the disc 110.

As described above, the light receiving elements in each of the absolute light receiving arrays (PA1, PA2) are arrayed along the arc-shaped line (Lcp) with the measurement center (Os) as a center of curvature; and the optical center (Op) is positioned at a position that is significantly distanced from the measurement center (Os). Therefore, light intensity in the light receiving elements of the light receiving arrays (PA1, PA2) varies according to a distance from the light source 131 in the measurement direction (C). Specifically, in the case of the light receiving array (PA2), as described above, the light receiving array (PA2) has a line-symmetrical shape about the line (Lo). Therefore, among the light receiving elements, the light intensity is the highest for a light receiving element (P5) positioned on the line (Lo), and is line-symmetrically reduced in the order of proximity to the line (Lo), that is, in the order of light receiving elements (P4, P6), light receiving elements (P3, P7), light receiving elements (P2, P8) and light receiving elements (P1, P9). The same also applies to the light receiving array (PA1). Further, the light receiving array (PA1) and the light receiving array (PA2) are provided sandwiching the light source 131 therebetween. Therefore, the light intensity in each of the light receiving elements of the light receiving arrays (PA1, PA2) is the highest at an edge (Eo) on the light source side, and is the lowest at an edge (En) on an opposite side of the light source 131.

Here, in the present embodiment, as described above, each of the light receiving elements is formed, for example, by a photodiode, and outputs a detection signal of an analog value according to a received light amount that is received by the entire light receiving area of the light receiving element. The received light amount is obtained by integrating light intensities at light receiving points in the light receiving area. Therefore, in the case where the above-described light intensity distribution is different between the light receiving elements, even when the light receiving areas are the same, the received light amounts are different, and variation characteristics of analog detection signals are different between the light receiving elements. In this case, variation timing of binary signals is shifted between the light receiving elements and thus there is a possibility of causing a false detection of an absolute position. Further, it may be possible that thresholds for binary signal conversion are each adjusted in correspondence to the variation characteristics of each of the light receiving elements so that the variation timing of binary signals is not shifted between the light receiving elements. However, this complicates a circuit structure and signal processing, and can be a factor causing an increase in cost and the like.

On the other hand, it may also be possible to adopt an approach in which the received light amounts of the light receiving elements are uniformized by changing the light receiving areas by respectively adjusting external dimensions of the light receiving elements in the measurement direction (C) or in the width direction (R). However, when the external dimensions of the light receiving elements in the measurement direction (C) are changed, intervals between adjacent light receiving elements become non-uniform. Therefore, due to an influence such as irregular reflection between the light receiving elements, crosstalk amounts caused by mutually leaked light reception (light amounts of light reception which fails to reach respective light receiving elements but are obtained by adjacent light receiving elements) become non-uniform and, as a result, there is a possibility that the received light amounts are non-uniformized. Further, when the external dimensions of the light receiving elements in the width direction (R) are changed, a light receiving element having a shorter length in the width direction is more likely to be influenced by a positional shift of the reflected light in the width direction due to eccentricity of the disc 110, and there is a possibility that a false detection occurs.

Therefore, in the present embodiment, in each of the light receiving array (PA1) and the light receiving array (PA2), maximum external dimensions in the measurement direction (C), and also maximum external dimensions in the width direction (R), of the light receiving elements, are formed to be equal to each other, and light receiving elements having different distances from the light source 131 are formed to have different shapes so that the received light amounts of the light receiving elements are equal to each other. Here, the description that the external dimensions or the received light amounts are equal does not mean that they are equal in a strict sense, but means that they are substantially equal when tolerances and errors in design and in manufacturing are within allowed ranges. Further, here the “received light amount” means a maximum received light amount in the case where each of the light receiving elements receives the reflected light with its entire light receiving area.

In the present embodiment, as an example of a shape that realizes such conditions, in the light receiving arrays (PA1, PA2), for some or all of the light receiving elements, low sensitivity regions are formed on an inner side of a high sensitivity region of a quadrangular shape such that corners of the quadrangular shape remain. The position mode of the low sensitivity regions are not particularly limited. However, in the present embodiment, a case is described where the low sensitivity regions are formed so that the high sensitivity region has an inner-cutout shape. Here, the light receiving array (PA2) of the light receiving arrays (PA1, PA2) is described in more detail as an example. The light receiving array (PA1) has the same shape as the light receiving array (PA2) except that the light receiving array (PA1) and the light receiving array (PA2) are symmetrical with respect to each other in the width direction (R), and thus, a description of the light receiving array (PA1) is omitted.

### Details of Shape of Light Receiving Element Having Low Sensitivity Regions

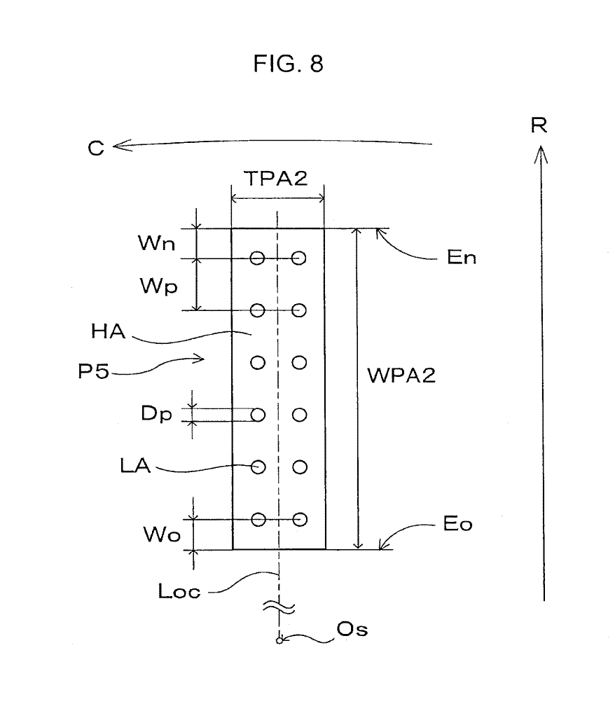

FIG. 8 illustrates, as an example, an enlarged view of a shape of the light receiving element (P5) that is one of the nine light receiving elements that the light receiving array (PA2) has. With reference to FIG. 8, shapes and dimension settings of parts of a light receiving element that has low sensitivity regions are described in detail.

The light receiving element (P5) has a shape in which, schematically, at multiple places (twelve places in this example) on an inner side of a high sensitivity region (HA) that is formed in a quadrangular shape, for example, circular low sensitivity regions (LA) are formed so as to have inner-cutout shapes. The quadrangular shape that is the external shape of the high sensitivity region (HA) is a rectangular shape having a length (TPA2) in the measurement direction (C) (in this example, a length of ε times the minimum length (P) (basic bit length) of the reflection slits of the pattern (SA2) in the measurement direction (C)) and a length (WPA2) in the width direction (R). In all of the light receiving elements (P1-P9) of the light receiving array (PA2), this basic rectangular shape, that is, the shape with the maximum external dimension (TPA2) in the measurement direction (C) and the maximum external dimension (WPA2) in the width direction (R), is commonly and equally set.

It is sufficient for the above-described basic quadrangular shape to be a substantially quadrangular shape without the need of requiring two opposing sides to be strictly parallel to each other and without the need of requiring each corner to strictly form a right angle. Further, for the light receiving elements (P1-P9), the maximum external dimensions (TPA2) in the measurement direction (C), and also the maximum external dimensions (WPA2) in the width direction (R), are not required to be strictly equal to each other, but may be substantially equal to each other. Further, the shape of the high sensitivity region (HA) of each of the light receiving elements may be a polygonal shape other than a quadrangular shape.

Here, the high sensitivity region (HA) is a region having a uniform high light receiving sensitivity of a predetermined degree at light receiving points in the region, and the low sensitivity region (LA) is a region having a uniform low light receiving sensitivity as compared to the high sensitivity region (HA). In the present embodiment, the light receiving sensitivity of the low sensitivity region (LA) is substantially zero (no light receiving functionality). Examples of method for forming the low sensitivity region (LA) include: providing a region where a PN junction is not formed at a predetermined place by masking the place when the light receiving element (P5) is created as an optical semiconductor; locally destroying a PN junction using laser or the like after the PN junction is formed in the entire region of the light receiving element (P5); and masking (forming a resist on) a predetermined place in a PN junction region using a non-translucent material. However, the low sensitivity region (LA) may also be formed using a method other than these. The high sensitivity region (HA) corresponds to an example of a first region, and the low sensitivity region (LA) corresponds to an example of a second region.

Further, in the example of the present embodiment, in all the light receiving elements (P1-P9), low sensitivity regions (LA) are formed in circular shapes of the same diameter (Dp). In each of the light receiving elements (P1-P9), the low sensitivity regions (LA) are formed at places positioned in two rows that are symmetrical with respect to a center line (Loc) of the measurement direction (C) with six places being included in each row (total 12 places). That is, the light receiving areas of the high sensitivity regions (HA) of the light receiving elements (P1-P9) are equal to each other. By forming the low sensitivity regions (LA) in two rows as described above, the high sensitivity region (HA) of each light receiving element has the maximum dimension in the width direction (R) at a center position of the light receiving element in the measurement direction (C). Further, when an edge distance from a center of a low sensitivity region (LA) on a side closest to the light source 131 to the edge (Eo) on the light source side of the light receiving element is Wo and an edge distance from a center of a low sensitivity region (LA) on a side farthest from the light source 131 to the edge (En) of the light receiving element on the opposite side of the light source 131 is Wn, in the present embodiment, in each of the rows of the low sensitivity regions (LA) in the same light receiving element, the two edge distances (Wo, Wn) are equal to each other (Wo=Wn), and the low sensitivity regions (LA) are formed equal intervals (pitches (Wp)) in the width direction (R).

It is also possible that the low sensitivity regions (LA) each have a shape other a circular shape. Further, the number and the position of the low sensitivity regions (LA) are also not limited to those described above. However, in the present embodiment, for convenience of description, a case where the low sensitivity regions (LA) are formed as described above is described.

Further, in all of the light receiving elements (P1-P9), the low sensitivity regions (LA) are formed so as to allow corners of the quadrangular high sensitivity region (HA) to remain (in other words, the low sensitivity regions (LA) are formed so as to not overlap with any of the corners). Therefore, in all of the light receiving elements (P1-P9), the maximum external dimension (TPA2) in the measurement direction (C), and also the maximum external dimension (WPA2) in the width direction (R), are equally secured. In the light receiving element (P5) illustrated in FIG. 8, the two edge distances (Wo, Wn) are set to be relatively short. Therefore, the twelve low sensitivity regions (LA) are substantially uniformly formed over the entire high sensitivity region (HA) of the light receiving element (P5). The light receiving elements (P1-P9) correspond to examples of first light receiving elements.

As described above in FIG. 7, the light intensity in each light receiving element is the highest at the edge (Eo) on the light source side and is the lowest at the edge (En) on the opposite side of the light source 131. Therefore, for the light receiving elements, even when areas of the low sensitivity regions (LA) are the same, that is, even when the light receiving areas of the high sensitivity regions (HA) are the same, the received light amount of each of the light receiving elements can be adjusted by the position mode of the low sensitivity regions (LA). For example, the received light amount can be relatively reduced when the low sensitivity regions (LA) are formed to concentrate on the edge (Eo) side close to the light source 131 as compared to a case where the low sensitivity regions (LA) are formed to concentrate on the edge (En) side far from the light source 131. Further, the received light amount can be relatively reduced when the low sensitivity regions (LA) are formed at positioned closer to the light source 131 as compared to a case where the low sensitivity regions (LA) are formed at positions farther from the light source 131.

Further, as described with reference to FIG. 7, the light intensity in the light receiving elements (P1-P9) of the light receiving array (PA2) is higher at a place closer to the line (Lo) (that is, the light intensity is higher for a light receiving element positioned closer to the light source 131 on the substrate (BA)) and is lower at a place farther from the line (Lo) (that is, the light intensity is lower for a light receiving element positioned farther from the light source 131 on the substrate (BA)). Therefore, in the present embodiment, in the light receiving element (P5) that is positioned closest to the light source 131, the two edge distances (Wo, Wn) are set to be the shortest, and the low sensitivity regions (LA) are substantially uniformly formed over the entire high sensitivity region (HA). Then, with the received light amount of the light receiving element (P5) as a reference, the position of the low sensitivity regions (LA) in each of the light receiving elements (P1-P4, P6-P9) is adjusted so that the received light amount of each of the light receiving elements (P1-P4, P6-P9) is the same as that of the light receiving element (P5) In other words, the low sensitivity regions (LA) are formed in the high sensitivity region (HA) in such a mode that the received light amounts of the light receiving elements (P1-P9) are equal to each other. Here the received light amount means a maximum received light amount in the case where each of the light receiving elements receives the reflected light with its entire light receiving area.

From the above, the light receiving elements (P1-P9) of the light receiving array (PA2) can have shapes, for example, as illustrated in FIGS. 5 and 7. In the example illustrated in FIGS. 5 and 7, the low sensitivity regions (LA) are formed at positions closer to the light source 131 for a light receiving element that is positioned closer to the light source 131 in the measurement direction (C). Further, the low sensitivity regions (LA) are formed at different formation densities for light receiving elements that are positioned at different distances from the light source 131. Specifically, in the light receiving element (P5) that is positioned closest to the light source 131, the above-described edge distances (Wo, Wn) are set to be the shortest, and the low sensitivity regions (LA) are substantially uniformly formed over the entire high sensitivity region (HA). In the light receiving elements (P1-P4, P6-P9) other than the light receiving element (P5), the low sensitivity regions (LA) are formed such that the two edge distances (Wo, Wn) are longer and the pitch (Wp) is shorter for a light receiving element that is positioned farther from the light source 131, and the low sensitivity regions (LA) are formed to more concentrate in a center position in the width direction (R) for a light receiving element that is positioned farther from the light source 131. That is, in the light receiving elements (P1-P9), the low sensitivity regions (LA) are formed such that the concentration of the low sensitivity regions (LA) at the center position in the width direction (R) in inverse proportion to the distance from the light source 131. By adjusting the low sensitivity regions (LA) to have such positional relations in the nine light receiving elements (P1-P9), the received light amounts in the nine light receiving elements (P1-P9) are equal to each other. That the received light amounts of the light receiving elements are equal to each other may be that the received light amounts of the light receiving elements are substantially equal to each other to an extent that some errors can be tolerated.

The shapes of the light receiving elements (P1-P9) of the light receiving array (PA2) are not limited to those described above. For example, it is also possible that the low sensitivity regions (LA) are formed to open on edges of a light receiving element so that the high sensitivity region (HA) has a shape other than an inner-cutout shape. Further, it is also possible that the sizes of the low sensitivity regions (LA) of the light receiving elements are modified and, for some or all of the light receiving elements (P1-P9), the areas of the light receiving elements are different from each other. Further, it is also possible that the relation between the edge distances (Wo, Wn) and the relations of the formation densities of the low sensitivity regions (LA) in the light receiving elements (P1-P9) are also different from those described above. Further, it is also possible that the low sensitivity regions (LA) are not provided in all of the light receiving elements but only in some of the light receiving elements. However, in the present embodiment, for convenience of description, a case where the light receiving elements (P1-P9) have the shapes as described above is described.

Thus, for each of the light receiving array (PA1) and the light receiving array (PA2), it is possible that the received light amounts of the light receiving elements are equal to each other while the maximum external dimensions of the light receiving elements in the measurement direction (C) and also the maximum external dimensions of the light receiving elements in the width direction (R) are equal to each other.

The low sensitivity regions (LA) are formed such that the dimension in the width direction (R) of the high sensitivity region (HA) of each light receiving element is the largest at the center position on the light receiving element in the measurement direction (C). Thereby, a particularly advantageous effect can be obtained when a detection signal of the light receiving element is converted into a binary signal. In the following, the effect is described in detail.

### Effect of Position of Low Sensitivity Regions During Binary Signal Conversion

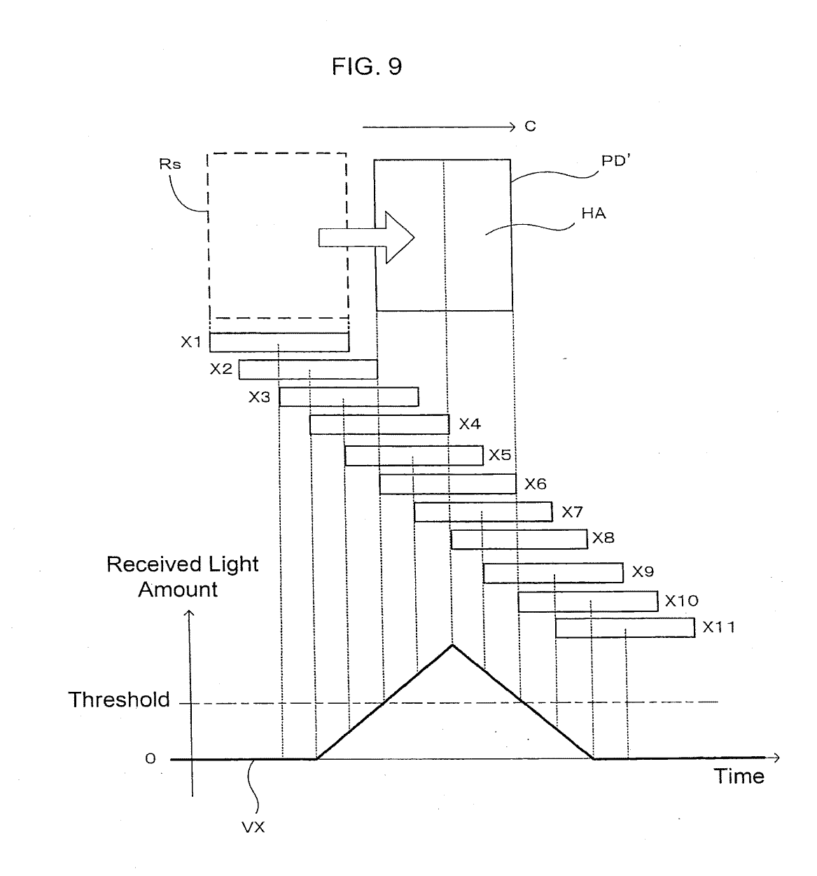

First, as a first comparative example, an example of variation characteristics of an analog detection signal in a case of a rectangular light receiving element (PD′) in which the low sensitivity regions (LA) are not formed (only the high sensitivity region (HA) is formed) is described with reference to FIG. 9. In FIG. 9, relative to the rectangular light receiving element (PD′), an irradiation surface (Rs) of the reflected light from the reflection slits of the patterns (SA1, SA2) proceeds in the order of positions (X1-X11) along the measurement direction (C) as time passes. The irradiation surface (Rs) has a rectangular shape that is larger than the light receiving element (PD′) in the width direction (R) and is the same as the light receiving element (PD′) in the measurement direction (C). Here, light intensity distribution in the irradiation surface (Rs) is assumed to be uniform. In correspondence to the positions (X1-X11), a received light amount in the light receiving element (PD′) varies over time with variation characteristics as illustrated by a thick line (VX).

In this case, from the timing of the position (X2) at which the irradiation surface (Rs) begins to overlap with the light receiving element (PD′) to the timing of the position (X6) at which the irradiation surface (Rs) completely overlaps with the light receiving element (PD′), the received light amount linearly monotonically increases. Further, from the timing of the position (X6) at which the received light amount is the largest to the timing of the position (X10) at which the overlapping between the irradiation surface (Rs) and the light receiving element (PD′) vanishes, the received light amount linearly monotonically decreases.

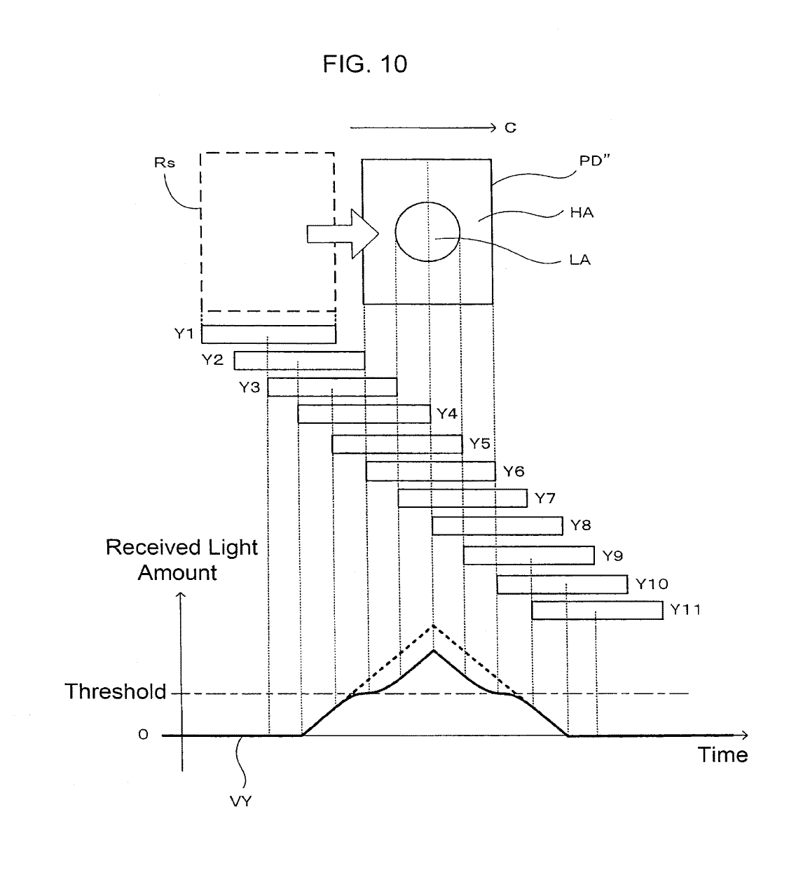

On the other hand, as a second comparative example, an example of variation characteristics of an analog detection signal in a case of a light receiving element (PD″) in which a circular low sensitivity region (LA) is formed in a measurement direction center part of the high sensitivity region (HA) is illustrated in FIG. 10. External shapes of the light receiving element (PD″) and the irradiation surface (Rs) in FIG. 10 are respectively assumed to be equal to the light receiving element (PD′) and the irradiation surface (Rs) in FIG. 9. In FIG. 10, relative to the light receiving element (PD″), the irradiation surface (Rs) proceeds in the order of positions (Y1-Y11) as time passes. In this case, in correspondence to the positions (Y1-Y11), a received light amount in the light receiving element (PD″) varies over time with variation characteristics as illustrated by a thick line (VY).

In this case, from the timing of the position (Y2) at which the irradiation surface (Rs) begins to overlap with the light receiving element (PD″) to the timing of the position (Y3) at which the irradiation surface (Rs) begins to overlap with the low sensitivity region (LA), the received light amount linearly monotonically increases. Further, from the timing of the position (Y3) to the timing of the position (Y5) at which the irradiation surface (Rs) completely overlaps with the low sensitivity region (LA), the received light amount quadratically increases (may also increase as a third or higher order function of time). During this time period, the timing of the position (Y4) at which the irradiation surface (Rs) overlaps with a half of the low sensitivity region (LA) becomes an inflection point. At this point, a time rate of change of the received light amount (slope of the curve) is the smallest. From the timing of the position (Y5) to the timing of the position (Y6) at which the irradiation surface (Rs) completely overlaps with the light receiving element (PD″), the received light amount linearly monotonically increases. Further, from the timing of the position (Y6) to the timing of the position (Y10) at which the overlapping between the irradiation surface (Rs) and the light receiving element (PD″) vanishes, the received light amount decreases with characteristics that are symmetrical to those described above for the time period from the timing of the position (Y2) to the timing of the position (Y6).

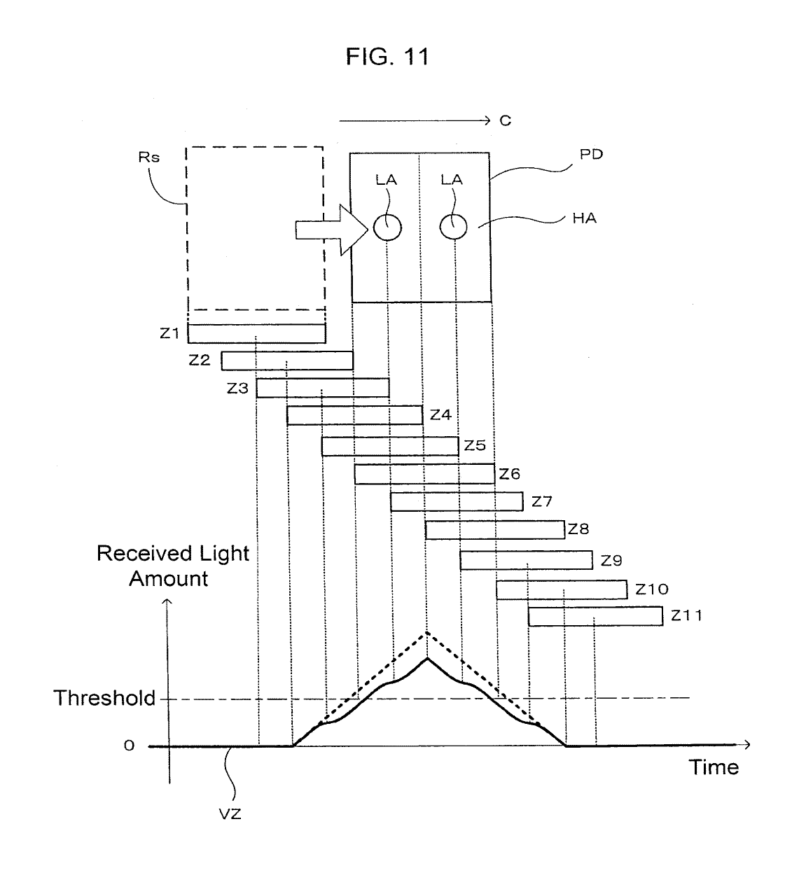

On the other hand, as in the case of the light receiving elements (P1-P9) of the present embodiment, in a case where two circular low sensitivity regions (LA) are formed side by side in symmetrical shapes in the measurement direction (C) in a light receiving element (PD), the received light amount varies over time with variation characteristics as illustrated by a thick line (VZ) in FIG. 11. That is, the thick line (VZ) in this case has two quadratic curve sections in each of an increasing section in a first half and a decreasing section in a second half, the two quadratic curve sections being similar to those illustrated in FIG. 10.

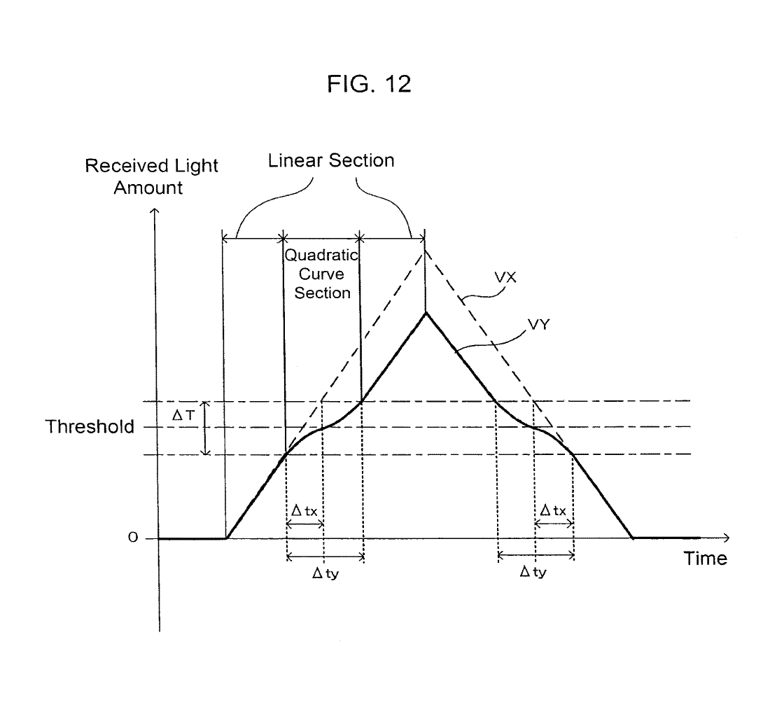

Here, as illustrated in FIG. 12, the variation characteristics of the received light amount in the case of the light receiving element (PD′) and the variation characteristics of the received light amount in the case of the light receiving element (PD″) are compared with each other. In FIG. 12, to make the comparison easy, it is assumed that the maximum external dimensions of the high sensitivity regions (HA) of the light receiving element (PD′) and the light receiving element (PD″) are equal, and the light receiving element (PD′) and the light receiving element (PD″) are irradiated with irradiation light of the same light intensity with a uniform distribution.

In general, it is desirable that a threshold for converting an analog detection signal from a light receiving element to a binary signal be set to a value that is one half of the maximum received light amount of the light receiving element. However, for example, due to variation in light intensity of irradiation light caused by deterioration over time and an individual manufacturing difference of the light source 131, or due to variation in light receiving sensitivity caused by deterioration over time and an individual manufacturing difference of a light receiving element, it is possible that the threshold relatively varies with respect to the variation characteristics of the received light amount. As illustrated in FIG. 12, variation of the threshold is in a range of a variation range (AT) around a reference value that is one half of the above-described maximum received light amount. However, in the case of the light receiving element (PD′), variation timing of a binary signal varies in a corresponding variation range (Δtx), whereas in the case of the light receiving element (PD″), as described above, since the time rate of change (the slope of the curve) of the received light amount near the threshold is the smallest, the variation range of the variation timing of the binary signal spreads to a variation range (Δty) that is wider than the variation range (Δtx), influence by the variation of the threshold is likely to occur.

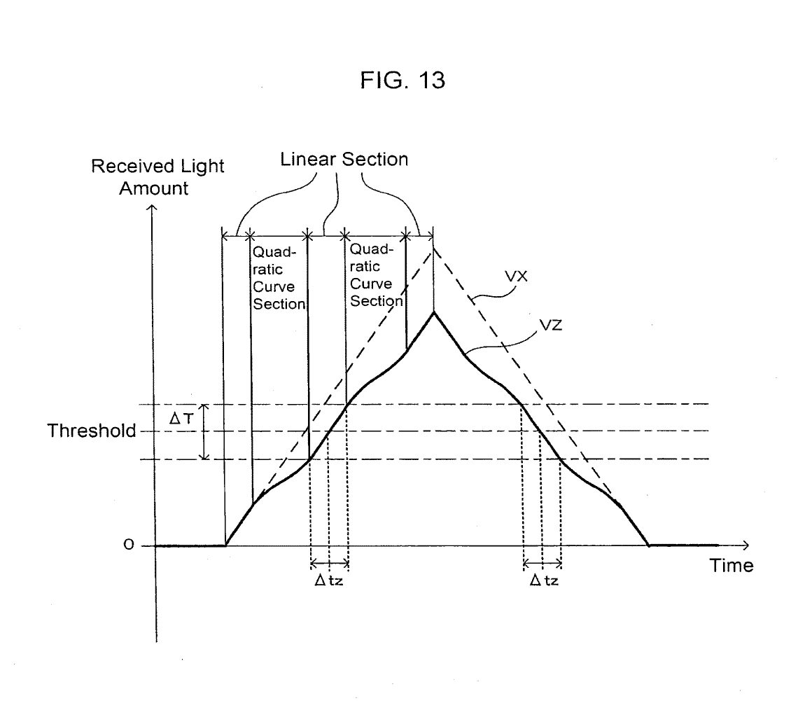

In contrast, as illustrated FIG. 13, in the case of the variation characteristics (VZ) of the light receiving element (PD), a linear section can overlap with the range of the variation range (ΔT) of the threshold around the reference value that is one half the maximum received light amount. As a result, the variation range of the variation timing of the binary signal is substantially equal to the variation range (Δtx) and is narrower than the variation range (Δtz), and the variation range of the variation timing of the binary signal can be equally suppressed as in the case of the light receiving element (PD′). That is, an effect is obtained of suppressing the influence due to the variation of the threshold when an analog detection signal is converted into a binary signal. This effect can be obtained by allowing the low sensitivity regions (LA) to have shapes or to have a position such that the dimension of the high sensitivity region (HA) in the width direction (R) (an effective length dimension excluding the low sensitivity regions (LA)) at the center position of the light receiving element in the measurement direction (C) is maximized. Therefore, for example, even when the low sensitivity regions (LA) are formed in formation other than the two-row formation, as long as the formation is such that the effective length dimension of the high sensitivity region (HA) at the center position of the light receiving element in the measurement direction (C) is maximized, the same effect as described above can be obtained (not illustrated in the drawings).

### Examples of Effects of Present Embodiment

In the above-described embodiment, the encoder 100 has the light receiving arrays (PA1, PA2) that are each arrayed along the measurement direction (C) and receive light that is emitted from the light source 131 and is reflected by the patterns (SA1, SA2). These light receiving arrays (PA1, PA2) each include the light receiving elements (P1-P9) in each of which, on the inner side of the quadrangular high sensitivity region (HA), the low sensitivity regions (LA) having a reduced light receiving sensitivity than the high sensitivity region (HA) are formed such that corners of the quadrangular shape of the high sensitivity region (HA) remain. As a result, by adjusting the mode (formation, area, density, shape and the like) of each of the low sensitivity regions (LA) in the light receiving elements (P1-P9), the shape and the area of the high sensitivity region (HA) can be varied and the received light amount of each of the light receiving elements can be adjusted. As a result, the received light amount of each of the light receiving elements (P1-P9) can be uniformized. Therefore, the detection accuracy of each bit can be uniformized, a false detection of the absolute position can be suppressed, and the detection accuracy can be improved. Further, a process adjusting signal output of each of the light receiving elements (P1-P9) is not required, and the threshold for converting an analog signal from each of the light receiving elements (P1-P9) to a binary signal can be made common for all the light receiving elements (P1-P9). Therefore, the circuit structure can be simplified.

Further, by forming the low sensitivity regions (LA) such that corners of the high sensitivity region (HA) that is formed in the quadrangular shape remain, the maximum external dimensions (TPA2) of the light receiving elements (P1-P9) in the measurement direction (C) can be made to equal to each other. As a result, the intervals between the light receiving elements (P1-P9) in the measurement direction (C) can be substantially uniformized, and the crosstalk amounts between light receiving elements that adjacent to each other in the measurement direction (C) can be uniformized. Therefore, the uniformity of the received light amounts of the light receiving elements (P1-P9) can be further improved. Further, a process in which noises due to the crosstalks are removed from signals of the light receiving elements (P1-P9) can be easily performed.

Further, as described above, for example, in the case where the length of a light receiving element in the width direction (R) is shortened as it approaches the light source 131, a light receiving element having a shorter length in the width direction (R) is more influenced by a positional shift of light in the width direction (R) due to the eccentricity of the disc 110, and a false detection is more likely to occur. In the present embodiment, by forming the low sensitivity regions (LA) such that corners of the quadrangular shape remain, the maximum external dimensions (WPA2) of the light receiving elements (P1-P9) in the width direction (R) can be made to equal to each other. As a result, the above-described influence due to the eccentricity can be reduced and, even when the eccentricity exists in the disc 110, it is possible that a detection error of the absolute position is less likely to occur.

Further, in the present embodiment, in the case where the low sensitivity regions (LA) are formed such that the high sensitivity region (HA) has an inner-cutout shape, the following effect is obtained. That is, by adopting the above-described formation, the external shapes of the light receiving elements (P1-P9) can be made common to each other. As a result, the above-described crosstalk amounts can be uniformized, and the effect of improving the robustness against the eccentricity can be further enhanced.

Further, in the present embodiment, in the case where the low sensitivity regions (LA) in each of the light receiving elements (P1-P9) are each formed in the mode (formation, area, density, shape and the like) such that the received light amounts of the light receiving elements are equal to each other, as described above, an effect is obtained such as that a false detection of the absolute position can be suppressed and the detection accuracy can be improved.

Further, in the present embodiment, in the case where the low sensitivity regions (LA) are formed at positions closer to the light source 131 for a light receiving element that is positioned closer to the light source 131 in the measurement direction (C), the following effect is obtained. That is, from the property that light attenuates with an optical path length, irradiation intensity of light that is emitted from the light source 131 and is reflected by the patterns (SA1, SA2) has a concentric distribution around the light source 131, in which the irradiation intensity attenuates with distance away from the light source 131. In such a light intensity distribution, by forming the low sensitivity regions (LA) closer to the light source 131 for a light receiving element closer to the light source 131, it is possible that, while a received light amount is ensured for a light receiving element that is distanced away from the light source 131 by forming the high sensitivity region (HA) on the light source side (where the irradiation intensity is high), the received light amount is gradually reduced for a light receiving element closer to the light source 131 by forming the low sensitivity regions (LA) on the light source side. Therefore, the received light amounts of the light receiving elements can be uniformized.

Further, in the present embodiment, in the case where, for the light receiving elements (P1-P9), the low sensitivity regions (LA) are formed at different formation densities for light receiving elements that are positioned at different distances from the light source 131, the following effect is obtained. That is, as described above, the light intensity in each light receiving element is the highest at the edge (Eo) on the light source side and is reduced at a place closer to the edge (En) on the opposite side of the light source 131. In such a light intensity distribution, by concentratedly forming the low sensitivity regions (LA) at a place of a predetermined light intensity in each light receiving element, or, by forming the low sensitivity regions (LA) at a substantially uniform density over each entire light receiving element, even when the areas of the low sensitivity regions (LA) in the light receiving elements are the same, the received light amount in each light receiving element can be adjusted. Therefore, the received light amounts of the light receiving elements can be uniformized.

Further, in the present embodiment, in the case where the low sensitivity regions (LA) have shapes or have a formation such that the dimension of the high sensitivity region (HA) in the width direction (R) at the center position of the light receiving element in the measurement direction (C) is maximized, the following effect is obtained. That is, as illustrated in FIG. 9, in the case of the (for example, rectangular) light receiving element (PD′) in which the low sensitivity regions (LA) are not formed and only the high sensitivity region (HA) is formed, output variation of an analog detection signal when the irradiation surface (Rs) passes is linear monotonic increase and monotonic decrease. Further, as illustrated in FIG. 10, in the light receiving element (PD″) in which the low sensitivity region (LA) is formed at the measurement-direction center part of the light receiving element, a slope of the output variation of the analog detection signal near the threshold is reduced, and a phase shift with respect to the variation of the threshold is increased. On the other hand, as in the present embodiment, in the case where the low sensitivity regions (LA) are formed and have shapes or a formation such that the dimension of the high sensitivity region (HA) in the width direction (R) at the center position of the light receiving element in the measurement direction (C) is maximized, as illustrated in FIG. 11, the slope of the output variation of the analog detection signal near the threshold is substantially equal to that in the case of the light receiving element (PD′), that is, can be larger than that in the case of the light receiving element (PD″). As a result, the phase shift with respect to the variation of the threshold can be reduced as compared to the case of the light receiving element (PD″). Therefore, even when the threshold varies, it is possible that a detection error of the absolute position is less likely to occur.

Further, in the present embodiment, in the case where, for the light receiving elements (P1-P9), the maximum external dimensions (TPA2) in the measurement direction (C), and also the maximum external dimensions (WPA2) in the width direction (R), are equal to each other, in the same way as described above, an effect can be obtained that the crosstalk amounts can be uniformized and the robustness against the eccentricity can be improved.

Further, in the present embodiment, in the case where the light receiving elements that form the light receiving arrays (PA1, PA2) are arrayed in two parallel sets at mutually offset positions in the width direction (R) in a manner sandwiching the light source 131, the following effect is obtained. That is, when reliability of a detection signal is reduced due to that the light receiving elements on one side (for example, the light receiving array (PA2)) correspond to a transition region of the absolute pattern, a detection signal from the light receiving elements on the other side (for example, the light receiving array (PA1)) can be used, and vice versa. As a result, the reliability of the detection signal of the light receiving elements can be improved and the detection accuracy of the absolute position can be improved.

Further, in the present embodiment, in the case where the encoder 100 is structured as a reflection type encoder in which the light source 131 is a point light source that emits diffused light to the patterns (SA1, SA2), the patterns (SA1, SA2) are patterns that reflects the light emitted by the light source 131, and the light receiving elements of the light receiving arrays (PA1, PA2) receive the light reflected by the patterns (SA1, SA2), the following effect is obtained. That is, in the reflection type encoder, by using the point light source that emits diffused light, light intensity distribution of the reflected light from the patterns (SA1, SA2) is likely to have a trapezoidal shape that further spreads from an irradiation area corresponding to the patterns (SA1, SA2). Therefore, crosstalk is likely to occur between light receiving elements that are adjacent to each other in the measurement direction (C). Therefore, the present structure in which the crosstalk amount can be uniformized is more effective when it is applied to a reflection type encoder. Further, by structuring the encoder 100 as a reflection type encoder, the light receiving elements (P1-P9) of the light receiving arrays (PA1, PA2) can be positioned close to the light source 131. Therefore, the encoder 100 can be miniaturized.

### Modified Embodiments

In the above, the embodiment is described in detail with reference to the accompanying drawings. However, the scope of the technical ideas is of course not limited to the embodiment described here. It is clear that, for a person of ordinary skill in the field to which the above-described embodiment belongs, within the scope of the technical ideas described in the claims, various variations, modifications, combinations and the like can be conceived. Therefore, technologies resulting from performing these variations, modifications, combinations and the like naturally fall within the scope of the technical ideas. In the following, such modified embodiments are sequentially described. In the following description, a part that is the same as in the above-described embodiment is indicated using the same reference numeral symbol and description thereof is omitted as appropriate.

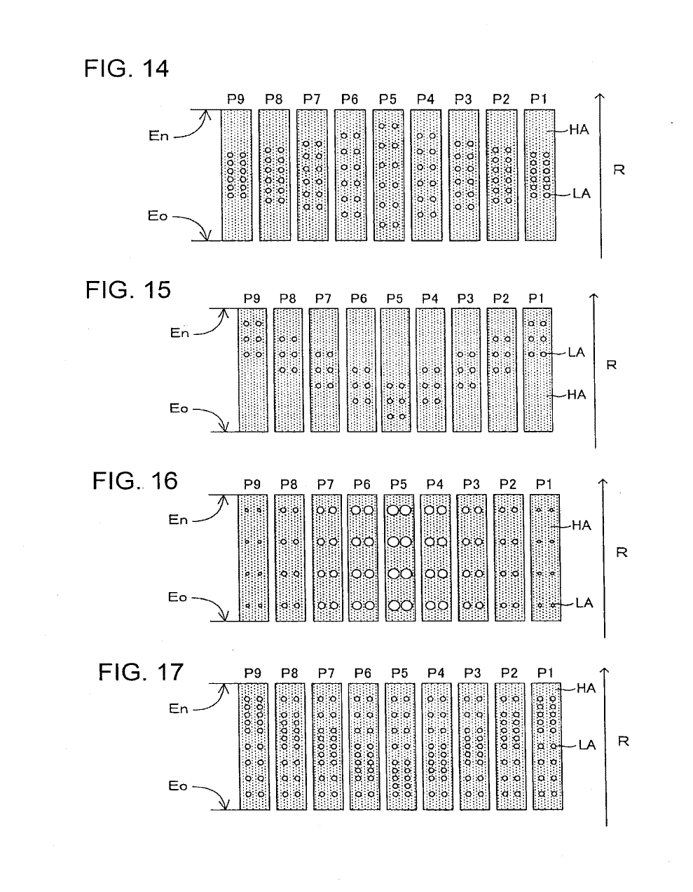

The shapes of the light receiving elements of the light receiving arrays (PA1, PA2) are not limited to those of the above-described embodiment, and various other shapes are also conceivable. In the following, using FIG. 14-23, variations of the shapes of the light receiving elements are described. In FIG. 14-23, only the shapes of the light receiving elements of the light receiving array (PA2) are illustrated, and illustration of other structures is omitted. Further, in practice, the light receiving elements are positioned along the arc-shaped line (Lcp) (arrayed along the measurement direction (C)). However, in FIG. 14-23, in order to facilitate understanding of relations between shapes of the light receiving elements, the light receiving elements are schematically illustrated in a linear formation.

### Shapes of the Light Receiving Elements

For comparison, FIG. 14 illustrates shapes of the light receiving elements of the light receiving array (PA2) in the above-described embodiment. In this example, the low sensitivity regions (LA) are formed at positions closer to the light source 131 for a light receiving element that is positioned closer to the light source 131 in the measurement direction (C). Further, the low sensitivity regions (LA) are formed at different formation densities for light receiving elements that are positioned at different distances from the light source 131. Specifically, in the light receiving element (P5) that is closest to the light source 131, the low sensitivity regions (LA) are substantially uniformly formed over the entire high sensitivity region (HA). For the light receiving elements (P1-P4, P6-P9) other than the light receiving element (P5), the low sensitivity regions (LA) are formed to more concentrate in a center position in the width direction (R) for a light receiving element that is positioned farther from the light source 131.

That the maximum external dimensions in the measurement direction (C) and also the maximum external dimensions in the width direction (R) of the light receiving elements are equal to each other and that the low sensitivity regions (LA) in each light receiving element are formed in a mode such that the received light amounts of the light receiving elements are equal to each other also apply to the modified embodiments to be described below.

Case where the Positions of the Low Sensitivity Regions are Modified

For example, the light receiving elements may have shapes as illustrated in FIG. 15. In this example, the light receiving elements (P1-P9) each have, for example, six circular low sensitivity regions (LA) each having the same diameter (Dp). The six low sensitivity regions (LA) are formed at the same density in a range shorter than the total length (WPA2) of each of the light receiving elements (P1-P9) in the width direction (R). The shapes and the number of the low sensitivity regions (LA) and the like are for illustrative purposes and are not limited to those described above (this applies also to the following modified embodiments). In the light receiving element (P5) that is closest to the light source 131, the six low sensitivity regions (LA) are formed closest to the edge (Eo) on the light source side. In a light receiving element distanced farther from the light source 131, the six low sensitivity regions (LA) are formed closer to the edge (En) on the far side of the light source 131. In other words, the low sensitivity regions (LA) are formed at positions closer to the light source 131 for a light receiving element that is positioned closer to the light source 131 in the measurement direction (C). Also in this modified embodiment, the same effect as that of the above-described embodiment can be obtained.

Case where the Areas of the Low Sensitivity Regions are Modified

Further, the light receiving elements may have shapes as illustrated in FIG. 16. In this example, in each of the light receiving elements (P1-P9), for example, eight circular low sensitivity regions (LA) are formed at a uniform density over the entire high sensitivity region (HA). In this example, the edge distances (Wo, Wn) and the pitches (Wp) in the light receiving elements (P1-P9) are respectively equal to each other. In the light receiving element (P5) that is closest to the light source 131, all of the low sensitivity regions (LA) are formed to have the largest diameter. In a light receiving element distanced farther from the light source 131, the low sensitivity regions (LA) are formed to have a smaller diameter.

As in this modified embodiment, for a light receiving element positioned closer to the light source 131 in the measurement direction (C), the area of the low sensitivity regions (LA) is more increased. Thereby, while the area of the high sensitivity region (HA) for a light receiving element distanced farther from the light source 131 is secured, the area of the high sensitivity region (HA) of a light receiving element positioned closer to the light source 131 can be gradually reduced. Therefore, the received light amounts of the light receiving elements (P1-P9) can be uniformized.

Case where the Formation Densities of the Low Sensitivity Regions are Modified

Further, the light receiving elements may have shapes as illustrated in FIG. 17. In this example, the light receiving elements (P1-P9) each have, for example, eighteen circular low sensitivity regions (LA) each having the same diameter (Dp). Of the eighteen low sensitivity regions (LA), for example, ten are densely formed at a relatively high density. The densely formed low sensitivity regions (LA) are formed closest to the edge (Eo) on the light source side in the light receiving element (P5) that is positioned closest to the light source 131, and are formed closer to the edge (En) on the far side of the light source 131 in a light receiving element that is distanced farther from the light source 131. The other eight low sensitivity regions (LA) are formed at a relatively low uniform density over the entire high sensitivity region (HA) in all of the light receiving elements (P1-P9). In other words, in all of the light receiving elements (P1-P9), the eighteen low sensitivity regions (LA) are formed over the entire high sensitivity region (HA). However, the formation density of the low sensitivity regions (LA) is different between the light receiving elements (P1-P9) having different distances from the light source 131.

According to this modified embodiment, while the received light amount can be secured for the light receiving elements (P1, P9) that are distanced from the light source 131 by increasing the formation density of the low sensitivity regions (LA) on the side distanced from the light source 131 (where the light intensity is low) (as a result, the area of the high sensitivity region (HA) on the light source 131 side is increased), the received light amount for a light receiving element that is distanced closer to the light source 131 can be gradually reduced by decreasing the formation density of the low sensitivity regions (LA) on the side distanced from the light source 131 (where the light intensity is low) (as a result, the area of the high sensitivity region (HA) on the light source 131 side is reduced). Therefore, the received light amounts of the light receiving elements can be uniformized.

Case where the Positions and the Areas of the Low Sensitivity Regions are Modified

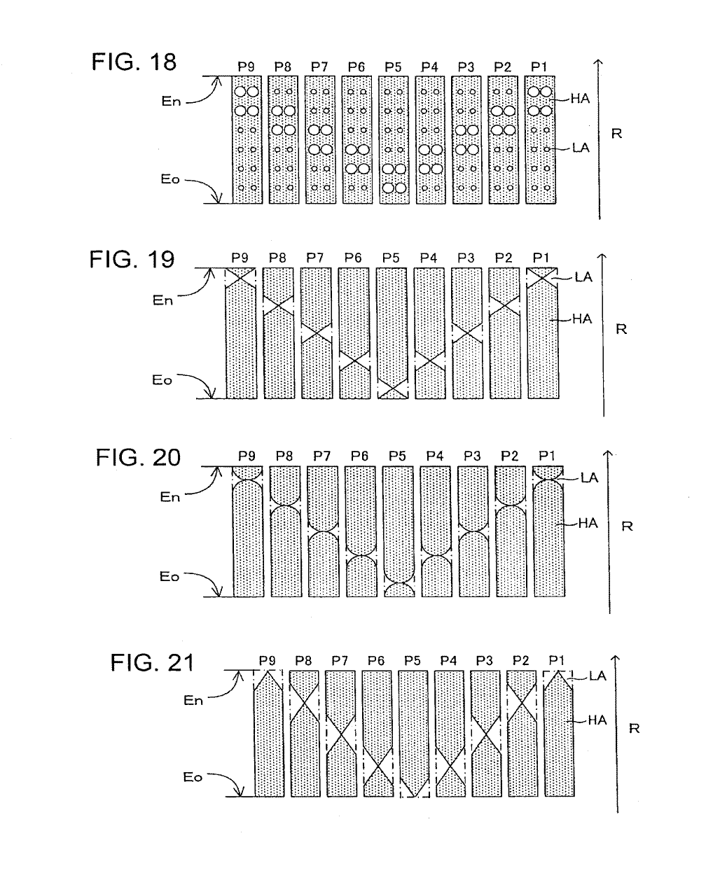

Further, the light receiving elements may have shapes as illustrated in FIG. 18. In this example, in each of the light receiving elements (P1-P9), for example, twelve circular low sensitivity regions (LA) are formed at a uniform density over the entire high sensitivity region (HA). Four of the low sensitivity regions (LA) have a diameter larger than that of the other low sensitivity regions (LA). The large-diameter low sensitivity regions (LA) are formed closest to the edge (Eo) on the light source side in the light receiving element (P5) that is positioned closest to the light source 131, and are formed closer to the edge (En) on the far side of the light source 131 in a light receiving element that is distanced farther from the light source 131. In other words, the four large-diameter low sensitivity regions (LA) are formed at positions closer to the light source 131 for a light receiving element that is positioned closer to the light source 131 in the measurement direction (C). Also in this modified embodiment, the same effect as that of the above-described embodiment can be obtained.

Case where the Low Sensitivity Regions have Shapes Other than Inner-Cutout Shapes

The shapes of the low sensitivity regions (LA) are not limited to inner-cutout shapes. For example, as illustrated in FIG. 19, it is also possible to have cutout-shaped low sensitivity regions (LA) that respectively open on edges on two opposing sides in the measurement direction (C) in a rectangular high sensitivity region (HA). In this example, in each of the light receiving elements, a pair of triangular low sensitivity regions (LA) is symmetrically formed in the measurement direction (C). In this case, the high sensitivity region (HA) has a shape that has two pointed portions that oppose each other in the width direction (R). The pair of the low sensitivity regions (LA) is formed closest to the edge (Eo) on the light source side in the light receiving element (P5) that is positioned closest to the light source 131, and is formed closer to the edge (En) on the far side of the light source 131 in a light receiving element that is distanced farther from the light source 131.

Further, for example, as illustrated in FIG. 20, it is also possible that a pair of cutout-shaped low sensitivity regions (LA) are formed in such shapes that two arcs oppose each other in the width direction (R). In this case, the high sensitivity region (HA) has a shape that has two semicircular end portions that oppose each other in the width direction (R). Also in the example illustrated in FIG. 20, the pair of the low sensitivity regions (LA) is formed at positions closer to the light source 131 in a light receiving element that is positioned closer to the light source 131 in the measurement direction (C).

Further, for example, as illustrated in FIG. 21, it is also possible that, for some of the light receiving elements, for example, for the light receiving elements (P1, P9) on two ends in the measurement direction and for the light receiving element (P5) at the center, low sensitivity regions (LA) are formed by removing corners of the quadrangular high sensitivity region (HA). In this case, the high sensitivity regions (HA) of the light receiving elements (P1, P9) each have a shape that has a pointed end portion on the opposite side of the light source 131 in the width direction (R), and the high sensitivity region (HA) of the light receiving element (P5) has a shape that has a pointed end portion on the light source 131 side in the width direction (R). For the remaining light receiving elements (P2-P4, P6-P8), the low sensitivity regions (LA) are formed such that the corners of the quadrangular high sensitivity region (HA) remain. In this example, in each of the light receiving elements, a pair of triangular low sensitivity regions (LA) is symmetrically formed in the measurement direction (C).

Also in the above modified embodiments, the same effect as that of the above-described embodiment can be obtained.

Case where the Width-Direction Dimension of the High Sensitivity Region is Minimized at the Measurement-Direction Center Position

As described above, in the case of suppressing the influence due to the variation of the threshold when an analog detection signal is converted into a binary signal, it is desirable that the low sensitivity regions (LA) have shapes or have a formation such that the dimension of the high sensitivity region (HA) in the width direction (R) at the center position of the light receiving element in the measurement direction (C) is maximized. However, the mode of the low sensitivity regions (LA) is not necessarily limited to this. For example, in a case where it is not necessary to consider the influence due to the variation of the threshold, the low sensitivity regions (LA) may have shapes or a formation such that the dimension of the high sensitivity region (HA) in the width direction (R) at the center position of the light receiving element in the measurement direction is minimized.

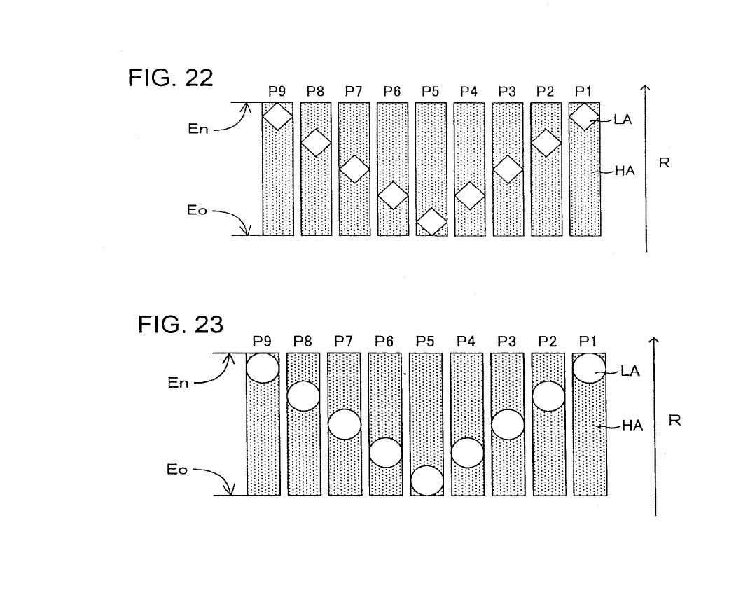

For example, as illustrated in FIG. 22, a quadrangular inner-cutout-shaped low sensitivity region (LA) may be formed in each of the light receiving elements. At least one diagonal dimension of the low sensitivity region (LA) is equal to the length dimension (TPA2) of the high sensitivity region (HA) in the measurement direction (C). Further, for example, as illustrated in FIG. 23, a circular inner-cutout-shaped low sensitivity region (LA) may be formed in each of the light receiving elements. The low sensitivity region (LA) has a diameter equal to the length dimension (TPA2) of the high sensitivity region (HA) in the measurement direction (C). In all of the examples illustrated in FIGS. 22 and 23, the low sensitivity region (LA) is formed closest to the edge (Eo) on the light source side in the light receiving element (P5) that is positioned closest to the light source 131, and is formed closer to the edge (En) on the far side of the light source 131 in a light receiving element that is distanced farther from the light source 131. The shapes and the number of the low sensitivity regions (LA) and the like are for illustrative purposes and are not limited to those described above.

Further, in the above description, “vertical,” “parallel,” “flat surface” or the like does not mean “vertical,” “parallel,” “flat surface” or the like in a strict sense. That is, “vertical,” “parallel” or “flat surface” means “substantially vertical,” “substantially parallel” or “substantially flat surface” when tolerances and errors in design and in manufacturing are within allowed ranges.

Further, in the above description, that dimensions and sizes in appearance are “same,” “equal,” “different,” or the like does not mean that the dimensions and sizes in appearance are “same,” “equal,” “different,” or the like in a strict sense. That is, “same,” “equal” or “different” means “substantially same,” “substantially equal” or “substantially different” when tolerances and errors in design and in manufacturing are within allowed ranges.

In an encoder, in order to improve detection accuracy, further optimization of device structure is desired.

An encoder according to an embodiment of the present invention allows detection accuracy to be improved, and another embodiment of the present invention is a motor with such an encoder.

An encoder according to one aspect of the present invention includes: an absolute pattern along a measurement direction; a light source that is structured to emit light to the absolute pattern; and multiple light receiving elements that are aligned along the measurement direction and are structured to receive light that is emitted from the light source and transmits through or is reflected by the absolute pattern. The light receiving elements include a first light receiving element in which, on an inner side of first region of a polygonal shape, a second region that has an optical sensitivity lower than that of the first region is formed such that corners of the polygonal shape remain.

Further, according to another aspect of the present invention, a motor with an encoder is provided that includes a motor and the above-described encoder.

According to an embodiment of the present invention, detection accuracy can be improved.

Obviously, numerous modifications and variations of the present invention are possible in light of the above teachings. It is therefore to be understood that within the scope of the appended claims, the invention may be practiced otherwise than as specifically described herein.

What is claimed is:

1. An encoder, comprising:
an object body having an absolute pattern formed along a measurement direction;
a light source positioned such that the light source is configured to emit light to the absolute pattern of the object body; and
a plurality of light receiving elements aligned along the measurement direction such that the plurality of light receiving elements is configured to receive the light transmitted through or reflected by the absolute pattern of the object body,
wherein the plurality of light receiving elements includes a first light receiving element having a polygonal shape and having a first region in the polygonal shape and a second region formed on an inner side of the first region such that the second region has an optical sensitivity lower than an optical sensitivity of the first region and that the first region includes corner portions of the polygonal shape.

2. An encoder according to claim 1, wherein the second region is formed such that the first region forms an inner-cutout shape.

3. An encoder according to claim 1, wherein the plurality of light receiving elements comprises the first light receiving element in a plurality, and the second region is positioned such that the first region has a same light received amount for each of the plurality of first light receiving elements.

4. An encoder according to claim 3, wherein the plurality of first light receiving elements is formed such that the second region of a first light receiving element positioned closer to the light source in the measurement direction is positioned closer to the light source.

5. An encoder according to claim 3, wherein the plurality of first light receiving elements is formed such that the second region of a first light receiving element positioned closer to the light source in the measurement direction has a greater area.

6. An encoder according to claim 3, wherein the second region is formed in a plurality in the first region of each of the first light receiving elements, and the plurality of first light receiving elements is formed such that a density of the plurality of second regions varies among the first light receiving elements based on distances from the light source.

7. An encoder according to claim 3, wherein the second region is formed such that the second region has a maximum width measured in a direction perpendicular to the measurement direction such that the maximum width is at a center position of a respective one of the first light receiving elements in the measurement direction.

8. An encoder according to claim 3, wherein the second region is positioned such that the second region has a maximum width measured in a direction perpendicular to the measurement direction such that the maximum width is at a center position of a respective one of the first light receiving elements in the measurement direction.

9. An encoder according to claim 1, wherein the plurality of light receiving elements is formed such that the light receiving elements have a same maximum external dimension in the measurement direction and a same maximum external dimension in a direction perpendicular to the measurement direction.

10. An encoder according to claim 1, wherein the plurality of light receiving elements comprises a first set of light receiving elements and a second set of light receiving elements positioned such that the light source is interposed between the first set and the second set arrayed parallel to each other and that the light receiving elements of the first set and the light receiving elements of the second set are positioned offset with respect to each other in a width direction perpendicular to the measurement direction.

11. An encoder according to claim 1, wherein the light source is a point light source configured to emit a diffused light toward the absolute pattern of the object body, the absolute pattern of the object body is a pattern which reflects the diffused light emitted by the point light source, and the plurality of light receiving elements is configured to receive the diffused lighted reflected by the absolute pattern.

12. An encoder according to claim 4, wherein the plurality of first light receiving elements is formed such that the second region of a first light receiving element positioned closer to the light source in the measurement direction has a greater area.

13. An encoder according to claim 4, wherein the second region is formed in a plurality in the first region of each of the first light receiving elements, and the plurality of first light receiving elements is formed such that a density of the plurality of second regions varies among the first light receiving elements based on distances from the light source.

14. An encoder according to claim 4, wherein the second region is formed such that the second region has a maximum width measured in a direction perpendicular to the measurement direction such that the maximum width is at a center position of a respective one of the first light receiving elements in the measurement direction.

15. An encoder according to claim 4, wherein the second region is positioned such that the second region has a maximum width measured in a direction perpendicular to the measurement direction such that the maximum width is at a center position of a respective one of the first light receiving elements in the measurement direction.

16. An encoder according to claim 5, wherein the plurality of first light receiving elements is formed such that the second region of a first light receiving element positioned closer to the light source in the measurement direction has a greater area.

17. An encoder according to claim 5, wherein the second region is formed in a plurality in the first region of each of the first light receiving elements, and the plurality of first light receiving elements is formed such that a density of the plurality of second regions varies among the first light receiving elements based on distances from the light source.

18. An encoder according to claim 5, wherein the second region is formed such that the second region has a maximum width measured in a direction perpendicular to the measurement direction such that the maximum width is at a center position of a respective one of the first light receiving elements in the measurement direction.

19. An encoder according to claim 5, wherein the second region is positioned such that the second region has a maximum width measured in a direction perpendicular to the measurement direction such that the maximum width is at a center position of a respective one of the first light receiving elements in the measurement direction.

20. A motor, comprising:
an encoder according to claim 1.
